(19) United States
(12) Patent Application Publication
(10) Pub. No.: US 2015/0051090 A1
(43) Pub. Date: Feb. 19, 2015

(54) METHODS FOR IN SILICO SCREENING

(71) Applicant: D.E. Shaw Research, LLC, New York, NY (US)

(72) Inventor: Yibing SHAN, Millburn, NJ (US)

(21) Appl. No.: 14/463,435

(22) Filed: Aug. 19, 2014

Related U.S. Application Data
(60) Provisional application No. 61/867,369, filed on Aug. 19, 2013.

(51) Int. Cl. C40B 30/02; G06F 19/16

(52) U.S. Cl. CPC C40B 30/02; G06F 19/16
USPC 506/8

(57) ABSTRACT

In one aspect, the invention relates to a method for identifying a small molecule which binds an evolved three dimensional topological feature on a target protein. In certain embodiments, the three dimensional topological feature evolves on the target protein as a result of binding by a biomolecule to the target protein. In certain embodiments, the small molecule modulates an activity of the target protein. In certain embodiments, the evolved three dimensional topological features are identified using molecular dynamics simulation.

This application claims the benefit of and priority to U.S. Provisional Patent Application No. 61/867,369 filed on Aug. 19, 2013, the contents of which are hereby incorporated by reference in its entirety.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described herein.

### BACKGROUND OF THE INVENTION

Protein-protein interactions are important in molecular biology. Identifying small molecules that bind to target proteins and modulate their interactions with other proteins has emerged as an increasingly common strategy for drug discovery. This is a departure from the convention, as most modern pharmaceuticals are small molecules that inhibit protein enzymes and disrupt the binding of small-molecule reactants.

Unlike enzyme-reactant binding sites that are typically well-formed pockets or clefts, a typical protein-protein interface is an extended and flat patch of protein surface. This represents a challenge for finding drugs that bind at protein-protein interfaces with sufficient specificity and affinity.

One central issue in this challenge is the lack of knowledge of well-defined drug binding sites for drug discovery. Such potential binding sites, however, do develop in protein dynamics, although they tend to be transient and underdeveloped, making them difficult to capture and characterize. There is a need for methods for identifying drug binding sites for drug discovery. This invention addresses this need.

### SUMMARY OF THE INVENTION

In certain aspects, the invention relates to a method of computer-assisted identification of a compound that modulates an activity of a target protein, the method comprising: (a) providing a structure of the target protein in complex with a biomolecule, or a fragment thereof, (b) performing a long timescale molecular dynamics simulation of the structure, (c) identifying one or more evolved three dimensional topological features on the target protein of the structure of step (a), and (d) identifying a compound that binds to at least one of the one or more evolved three dimensional topological features identified in step (c), wherein binding of the compound to the one or more evolved three dimensional topological features modulates an activity of the target protein.

In certain aspects, the invention relates to a method of computer-assisted identification of a compound that modulates an interaction between a target protein and a biomolecule, wherein the biomolecule is a binding partner of the target protein, the method comprising: (a) providing a structure of the target protein in complex with a biomolecule, or a fragment thereof, (b) performing a long timescale molecular dynamics simulation of the structure, (c) identifying one or more evolved three dimensional topological features on the target protein of the structure of step (a), and (d) identifying a compound that binds to at least one of the one or more evolved three dimensional topological features identified in step (c) wherein binding of the compound to the one or more evolved three dimensional topological features modulates an interaction between the target protein and the biomolecule or fragment thereof.

In certain aspects, the invention relates to a method of computer-assisted identification of one or more evolved three dimensional topological features on a target protein, the method comprising: (a) providing a structure of the target protein in complex with a biomolecule, or a fragment thereof, (b) performing a long timescale molecular dynamics simulation of the structure, (c) identifying one or more evolved three dimensional topological features on the target protein of the structure of step (a).

In certain embodiments, the structure of step (a) is determined by physical observation or in-silico modeling, or any combination thereof. In certain embodiments, the physical observation comprises NMR, X-ray crystallography, electron microscopy, or any combination thereof.

In certain embodiments, the structure of step (a) is a predicted structure.

In certain embodiments, the complex of step (a) comprises one or more covalent bonds.

In certain embodiments, the complex of step (a) comprises one or more non-covalent interactions.

In certain embodiments, the biomolecule, or a fragment thereof, is a known binding partner of the target protein.

In certain embodiments, the biomolecule, or a fragment thereof, is a polypeptide.

In certain embodiments, the biomolecule, or a fragment thereof, is a nucleic acid.

In certain embodiments, the biomolecule, or a fragment thereof, comprises an alpha helix.

In certain embodiments, the biomolecule, or a fragment thereof, consists essentially of an alpha helix.

In certain embodiments, the biomolecule, or a fragment thereof, comprises at least one of an alpha helix, a beta strand, a beta sheet, a beta hairpin, a greek key, an omega loop, a Helix-loop-helix, a helix-turn-helix, or a zinc finger motif.

In certain embodiments, the long timescale molecular dynamics simulation of step (b) is performed by a computer program using a neutral territory method, an Ewald summation method for molecular simulation, a spatial decomposition method, a force decomposition method, or any combination thereof.

In certain embodiments, the long timescale molecular dynamics simulation of step (b) is performed by a computer program using a physics method, an energy based method, or any combination thereof.

In certain embodiments, the long timescale molecular dynamics simulation is at least 100 nanoseconds.

In certain embodiments, the long timescale molecular dynamics simulation is at least 1000 nanoseconds.

In certain embodiments, the identification of the one or more evolved three dimensional topological features of step (c) is performed by a geometric algorithm, an energy based algorithm, a precedence based algorithm, or any combination thereof.

In certain embodiments, the evolved three dimensional topological feature is selected from the group comprising a groove, a hydrophobic pocket, a cavity or a cleft.

In certain embodiments, the evolved three dimensional topological feature exists transiently during the molecular dynamics simulation.

In certain embodiments, the evolved three dimensional topological feature exists at the termination of the molecular dynamics simulation.

In certain embodiments, the evolved three dimensional topological feature has a volume of about 930 A°³ as determined with Surface Cavity REcognition and EvaluatioN.

In certain embodiments, the evolved three dimensional topological feature has a volume between about 50 A°³ to about 3000 A°³ as determined with Surface Cavity REcognition and EvaluatioN.

In certain embodiments, the evolved three dimensional topological feature has a volume of about 610 A°³ as determined with PocketFinder.

In certain embodiments, the evolved three dimensional topological feature has a volume of about 50 A°³ to about 2000 A°³ as determined with PocketFinder.

In certain embodiments, the identifying of step (d) is performed by a computer program by docking, shape-based matching, free energy analysis, three-dimensional pharmacophore analysis, de novo drug design, fragment-based drug design, or any combination thereof.

In certain embodiments, at least one of the one or more evolved three dimensional topological features comprises an amino acid residue that forms a non-covalent interaction with an amino acid residue of the biomolecule, or a fragment thereof.

In certain embodiments, at least one of the one or more evolved three dimensional topological features comprises an amino acid residue that forms a non-covalent interaction with the compound of step (d).

In certain embodiments, the non-covalent interaction is selected from the group comprising an ionic interaction, an electrostatic interaction, a hydrogen bond, a van der Walls interaction or a hydrophobic interaction.

In certain embodiments, the compound has a molecular weight from about 100 daltons to about 1000 daltons.

In certain embodiments, the compound comprises a chemical group selected from the group consisting of hydrogen, alkyl, alkoxy, phenoxy, alkenyl, alkynyl, phenylalkyl, hydroxyalkyl, haloalkyl, aryl, arylalkyl, alkyloxy, alkylthio, alkenylthio, phenyl, phenylalkyl, phenylalkylthio, hydroxyalkyl-thio, alkylthiocarbbamylthio, cyclohexyl, pyridyl, piperidinyl, alkylamino, amino, nitro, mercapto, cyano, hydroxyl, a halogen atom, halomethyl, an oxygen atom (forming a ketone or N-oxide) and a sulphur atom (forming a thione).

In certain embodiments, wherein the compound is a polypeptide comprising at least a sequence of at least 4 amino acids.

In certain embodiments, the modulation is a decrease of an activity of the target protein.

In certain embodiments, the modulation is an increase of an activity of the target protein.

In certain embodiments, the modulation is a decrease of the interaction between the target protein and the biomolecule, or a fragment thereof.

In certain embodiments, the modulation is an increase in the interaction between the target protein and the biomolecule, or a fragment thereof.

In certain aspects, the invention relates to a method of computer-assisted identification of a compound that modulates an interaction between a target protein and an alpha helix biomolecule, wherein the alpha helix biomolecule is a binding partner of the target protein, the method comprising: (a) providing an X-ray structure of the target protein in complex with an alpha helix biomolecule, wherein the complex between the target protein and the alpha helix biomolecule comprises one or more non-covalent interactions, (b) performing a long timescale molecular dynamics of the structure using an explicit-solvent classic simulation, (c) identifying at least one cleft formed on the target protein of step (a) using SiteMap or manual visual inspection, and (d) performing virtual screening to identify at least one compound that binds to at least one of the clefts of step (c) using the Glide SP 2008 docking algorithm.

### BRIEF DESCRIPTION OF THE FIGURES

FIGS. 1A-C show an EGFR dimer system and the simulation system setup of a reduced complex. FIG. 1A shows a starting X-ray structure of a dimer of the EGFR kinase. One protein is rendered by surface, while the other by ribbon. The helix that remains in the simulation is colored red. FIG. 1B shows a simulation system of one EGFR kinase and one helix at the protein-protein interface. FIG. 1C shows a local view of the protein-protein interface and the helix.

FIGS. 2A-B show an EGFR protein-protein interface comparison. FIG. 2A shows a potential drug-binding site at the protein-protein interface as captured in the X-ray structure. A cluster of blue dots is used here to indicate the shape and volume of the site. FIG. 2B shows the potential drug-binding site at the same protein-protein interface as captured in the simulation of an EGFR kinase interacting with a helix. Note a well-formed cleft has developed due to the presence of the helix.

FIG. 3 shows the “druggability” of the two binding sites. Docking a library of drug-like chemical compounds to the binding sites shown FIG. 2 generates two sets of docking scores. A lower docking score indicates more favorable protein-ligand interaction. It is clear that the binding site induced by the remaining helix is more druggable because, overall, more compounds are identified that interact favorably with this potential binding site than with the one in the original crystal structure.

FIG. 4 shows examples of small molecules that interact favorably with the induced binding site.

### DETAILED DESCRIPTION OF THE INVENTION

The issued patents, applications, and other publications that are cited herein are hereby incorporated by reference to the same extent as if each was specifically and individually indicated to be incorporated by reference.

In certain aspects, the methods described herein relate to the finding that a flat surface on a protein may more readily develop a potential small molecule binding site when a suitable biomolecule is present. This general concept of “induced fit” can be employed in the context of molecular dynamics simulation as well as in reality. Without prior knowledge of the binding site and three-dimensional topological features, however, it is difficult to design a suitable small molecule, which is typically the end goal rather than a starting point. A drug discovery project targeting a protein-protein interface, therefore, faces an underlying chicken-or-egg problem.

In certain aspects, the methods described herein relate to the use of long timescale molecular dynamics simulation to compute interactions between a target protein and one or more partner biomolecules and/or to determine whether interaction with one or more partner biomolecules results in the evolution of three dimensional topological features and/or structures on the surface of the target protein. In certain embodiments, the evolved three dimensional topological features can further be analyzed to determine if they are druggable sites. For example, in certain embodiments, molecular dynamics simulation, when used according to the methods described herein, can be used in the design of one or more small molecules that bind to an evolved three dimensional topological feature. As is described further herein, many methods exist in the art for selecting compounds that bind a three dimensional topological feature, including, but not limited to, traditional docking programs (i.e. virtual screening programs) as well as molecular dynamics simulation algorithms suitable for modeling conformational changes to proteins and molecules.

The methods described herein can be used to model evolved three dimensional topological features that arise on one or more target proteins as a result of interaction with a biomolecule, as a result of conformational changes arising from the presence or absence of one or more intramolecular interactions within a target protein, or from modifications of the target protein. For example, one or more transient or non-transient three dimensional topological features can arise on a target protein as a result of binding to an identical protein, a different protein, or a non-protein biomolecule. Non-limiting examples of protein interactions include oligomeric or multimeric protein complexes, antigen-antibody interactions, hormone-receptor interactions, protein-substrate or protein-inhibitor interactions, and protein interactions in signal transduction pathways. In certain aspects, the methods described herein can be used to identify evolved three dimensional features on a target protein using molecular dynamics simulation algorithms. Thus in certain aspects, computational methods, such as molecular dynamics simulations, can be used to simulate and predict the conformation dynamics of structures.

The methods described herein can use known structures of target proteins in complex with their partner biomolecules and take advantage of long timescale molecular dynamics simulations. Such simulations can use a fragment of a biomolecule as a mimic of a full length biomolecule. One advantage of this approach is that the identity of an effective mimic, as well as the way it interacts with the target protein, can be derived from the structure and thereby preserve high-affinity interactions developed through evolution. Long timescale molecular dynamics simulations can then be used to simulate the target protein in complex with the biomolecule, in which potential binding sites develop. In certain embodiments, the biomolecules, or fragments thereof, are derived from actual protein-biomolecule interactions and have been individually optimized by evolution to interact favorably with a target protein. In certain embodiments, the biomolecules, or fragments thereof, are derived from predicted protein-biomolecule interactions. Although the methods described herein can further comprise modeling with inductants such as isopropyl alcohol (Seco, J. et al., J. Med. Chem. 52, 2363-2371, 2009), the three dimensional topological features on a target protein described herein arise from binding by a biomolecule and not by the inductants (such as isopropyl alcohol) alone.

In certain aspects, described herein are methods for identifying small molecules that interact with a target protein of interest and modulate its biological activity or other functional property, its conformational state, its ability to interact with one or more biomolecules, and/or its distribution and/or localization within a cell. The methods described herein can be used alone or in conjunction with any other screening methods known in the art. The methods described herein can also be used in connection with other methods known in the art to identify small molecules, mutations, biological mechanisms or therapeutic treatments, including, but not limited to, those methods that employ combinatorial chemistry, molecular biology, high throughput screening, structure-based drug design, in vitro, in-vivo, in-silico methods, and the like.

### DEFINITIONS

The singular forms “a,” “an,” and “the” include plural reference unless the context clearly dictates otherwise.

The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 20%.

As used herein, the terms “polypeptide,” “protein,” and “peptide” refer to a chain of covalently linked amino acids. Unless otherwise indicated, the term “polypeptide” encompasses both peptides and proteins. In general, the term “peptide” can refer to shorter chains of amino acids (e.g., 2-50 amino acids); however, all three terms overlap with respect to the length of the amino acid chain. Polypeptides may comprise naturally occurring amino acids, non-naturally occurring amino acids, or a combination of both. The polypeptides may be isolated from sources (e.g., cells or tissues) in which they naturally occur, produced recombinantly in cells in vivo or in vitro or in a test tube in vitro, or synthesized chemically. Such techniques are known to those skilled in the art. See, e.g., Sambrook et al., Molecular Cloning: A Laboratory Manual 2nd Ed. (Cold Spring Harbor, N.Y., 1989); Ausubel et al. Current Protocols in Molecular Biology (Green Publishing Associates, Inc. and John Wiley & Sons, Inc., New York). Accordingly, “polypeptide,” “protein,” and “peptide” as used herein encompass all naturally occurring, synthetic, and recombinant polypeptides and biologically active variants thereof.

As used herein, the term “small molecule” refers to a protein fragment or a polypeptide, a peptidomimetic, an amino acid, an amino acid analog, a nucleic acid sequence (comprising naturally occurring nucleic acids and/or non-naturally occurring nucleic acid), a nucleic acid, a nucleic acid analog, a nucleotide, a nucleotide analog, a carbohydrate, a lipid, a carbohydrate, a polysaccharide, a naturally occurring molecule, a synthetic molecule, an antagonist, an agonist, an organic compound or an inorganic compound (including heteroorganic and organometallic compounds), or any combination thereof. In certain embodiments, the small molecule can have a known chemical structure but not necessarily have a known function or biological activity. In certain embodiments, the small molecule can have a known structure but no known activity. In certain embodiments, the structure of the small molecule is identified according to the methods described herein. The structures of large numbers of small molecules can be randomly obtained and/or screened from physical or virtual chemical libraries, collections of chemical compounds or collections of crude extracts from various sources. The small molecules can be compounds capable of chemical synthesis or purification from natural products. The small molecules described herein can be novel, or they can be analogs or derivatives of known therapeutic small molecules. The small molecules identified according to the methods described herein can be of any size. In certain embodiments, the size of the small molecule will be between about 100 daltons to about 200 daltons, about 200 daltons to about 300 daltons, about 300 daltons to about 400 daltons, about 400 daltons to about 500 daltons, about 500 daltons to about 600 daltons, about 700 daltons to about 800 daltons, about 800 daltons to about 900 daltons, about 900 daltons to about 1000 daltons, or more than 1000 daltons.

In certain aspects, described herein are methods for identifying, via molecular dynamics simulation, small molecules capable of binding to three dimensional topological features that evolve on a target protein when the target protein is in complex with a biomolecule. One of skill in the art will understand that the conformational state of a target protein can determine its functional state. Accordingly, in certain embodiments, the biomolecule will be a molecule that is able to bind to, and form a complex with, a target protein and may, in certain embodiments, alter the biological activity of the target protein. A biomolecule suitable for use with the methods described herein can be, but is not limited to, a protein, a protein fragment, or a polypeptide, a peptidomimetic, an amino acid, an amino acid analog, a nucleic acid sequence (comprising naturally occurring nucleic acids and/or non-naturally occurring nucleic acid), a nucleic acid, a nucleic acid analog, a nucleotide, a nucleotide analog, a carbohydrate, a lipid, a carbohydrate, a polysaccharide, a naturally occurring molecule, a synthetic molecule, an antagonist, an agonist, an organic compound or an inorganic compound (including heteroorganic and organometallic compounds), or any combination thereof that binds to a target protein and alters the three dimensional conformation the target protein. In certain embodiments, binding of the biomolecule to the target protein can induce the formation of one or more transient or non-transient evolved three dimensional topological features on the target protein.

In certain embodiments, the biomolecule can be one that is known to interact with the target protein. In other embodiments, the biomolecule can be one that is predicted to interact with the target protein. The complexes of the target protein and biomolecules used in connection with the methods described herein can be, but are not limited to, complexes comprising a full length target protein bound to a full length biomolecule, complexes comprising a fragment of a target protein and a full length biomolecule, a full length target protein and a fragment of a biomolecule, or a fragment of a target protein and a fragment of a biomolecule. In embodiments where the biomolecule is a protein, the biomolecule can comprise one or more secondary structures, or consist essentially of a secondary structure, such as, for example, an alpha helix, a beta strand, a beta sheet, a beta hairpin, a greek key, an omega loop, a Helix-loop-helix, a helix-turn-helix, or a zinc finger motif, or any other secondary structure known in the art.

Biomolecules suitable for use with the methods described herein can bind to the target protein with high affinity or low affinity and can bind to the target protein through one or more non-covalent interactions, such as ionic interactions, electrostatic interactions, hydrogen bonds, van der Waals interactions, hydrophobic interactions, or any combination thereof. The biomolecule can also bind to the target protein through one or more covalent interactions. Biomolecules that bind to a target protein can bind reversibly or irreversibly.

The Input Structures

In certain aspects, the methods described herein comprise a step of providing a structure comprising a target protein in complex with a biomolecule for the purpose of computer-aided identification of one or more small molecules capable of modulating an activity of the target protein. The complexes suitable for use in connection with the methods described herein can be known (e.g. published) complexes, or complexes that are not already known in the art, including, but not limited to, target protein structures, biomolecule structures, and complexes obtained by physical observation or in-silico prediction/modeling. Where physical observation is used to determine the structure of a target protein or a biomolecule (of a complex) for use in connection with the methods described herein, suitable methods of physical observation include, but are not limited, to Nuclear Magnetic Resonance (NMR), electron microscopy, or X-ray crystallography. For example, in the case of X-ray crystallography, three-dimensional atomic coordinates of a target protein, or a target protein in complex with a biomolecule, can be derived by examining diffraction of X-rays through the structure in crystal form. Electron density maps can be then calculated using this diffraction data according to methods known in the art. Where the structure of the protein or biomolecule is known, structures already available in the art, including, but not limited to those available in publications or in databases, are suitable for use with the methods described herein. See, for example, the Protein Data Bank database (Berman et al. 2000. Nucleic Acids Res 28(1): 235-242; the Cambridge Structural Database (Allen, F. H. Acta Cryst. B58:380-388, 2002), and the Nucleic Acid Database Project (NDB) (Berman et al., Biophys. J 63:751-759, 1992).

In certain embodiments, the target protein and/or biomolecule structures used in connection with the methods described herein can be structures that are derived in whole or in part from in-silico methodologies. There are many in-silico methods for structure prediction and modeling that can be used in connection with the methods described herein, including, without limitation, comparative protein modeling methods (e.g., homology modeling methods such as those described in Marti-Renom et al. 2000. Annu Rev Biophys Biomol Struct 29: 291-325), protein threading modeling methods (such as those described in Bowie et al. 1991. Science 253: 164-170; Jones et al. 1992. Nature 358: 86-89), ab initio or de novo protein modeling methods (Simons et al. 1999. Genetics 37: 171-176; Baker 2000, Nature 405: 39-42; Wu et al. 2007. BMC Biol 5: 17), physics-based prediction (see inter alia Duan and Kollman 1998, Science 282: 740-744; Oldziej et al. 2005, Proc Natl Acad Sci USA 102: 7547-7552); or any combination thereof. Comparative modeling methods can be performed using a number of modeling programs, including, but not limited to, the “Modeller” (Fiser and Sali 2003, Methods Enzymol 374: 461-91) or “Swiss-Model” (Arnold et al. 2006, Bioinformatics 22: 195-201). Protein threading modeling methods can be performed using a number of modeling programs, including, but not limited to, “HHsearch” (Soding 2005, Bioinformatics 21: 951-960), “Phyre” (Kelley and Sternberg. 2009, Nature Protocols 4: 363-371) or “Raptor” (Xu et al. 2003, J Bioinform Comput Biol 1: 95-117). Ab initio or de novo protein modeling methods can be performed using a number of modeling programs including, but not limited to, “Rosetta” (Simons et al. 1999. Genetics 37: 171-176; Baker 2000, Nature 405: 39-42; Bradley et al. 2003, Proteins 53: 457-468; Rohl 2004, Methods in Enzymology 383: 66-93), and “I-TASSER” (Wu et al. 2007. BMC Biol 5: 17). Where in-silico modeling programs involve super-positioning of three dimensional structures of similar macromolecule, the macromolecules may be related, but not identical. Related macromolecules include polypeptide members of a particular gene family, polypeptides having topologically similar binding sites, or polypeptides having at least 10% homology within a domain of interest. Other criteria that can be used to determine if a macromolecule exhibits sufficient relatedness for super-positioning based molecular modeling include, but are not limited to, sequence homology of a polypeptide or nucleic acid to a macromolecule of interest, three-dimensional relatedness (e.g. similarity of molecular folds, or protein domains) as a function of similarity in the three dimensional configuration, order of secondary structures, or topological connections (Murzin et al., J. Mol. Biol. 247: 536-540, 1995). Databases useful for assessing similarities of three dimensional relatedness include, but are not limited to, the Structural Comparison of Proteins (SCOP), PROSITE (http://expasy.hcuge.ch).

Molecular Dynamics Programs

In certain aspects, the methods described herein comprise a step of using molecular dynamics simulation to identify three dimensional topological features that evolve on a target protein structure upon formation of a complex with a biomolecule. In certain aspects, the methods described herein can also comprise a step of using molecular dynamics simulation to identify three dimensional topological features that evolve on protein structure upon modification of the target protein (e.g. phosphorylation, ubiquitination, acetylation . . . etc). Thus, in certain embodiments, the methods described herein are useful for identifying small molecules that bind to an evolved three dimensional topological feature on a target protein arising as a result of binding by a biomolecule to the target protein. The evolved three dimensional topological feature can be a topological feature that arises transiently during the molecular dynamics simulation, or alternatively, the evolved three dimensional topological feature can be a feature that evolves upon completion of the simulation.

As used herein, the term “molecular dynamics simulation” refers to computer-aided simulation methods in which the time evolution of a set of interacting atoms, groups of atoms, or molecules is followed by integrating their equations of motion. Current molecular dynamics simulation methodologies suitable for use with the methods described herein differ from traditional molecular docking approaches that rely on rigid body algorithms for assessing three dimensional complementarity of static structures. In addition to predicting conformational flexibility in side chains, molecular dynamics simulation methodologies can be used to compute backbone and side chain conformational changes in proteins that arise as a result of binding interactions. In certain embodiments, the conformational changes that occur during binding can be used to simulate “induced fit” binding. As such, the molecular dynamics simulation methods suitable for use with the methods described herein can be useful for predicting conformational changes in proteins that occur upon binding by a biomolecule in a way that is not feasible with conventional docking methods that otherwise maintain an unchanged backbone conformation. For example, molecular dynamics simulation can be used in connection with the methods described herein to model protein-biomolecule combinations and to simulate binding induced conformational changes in a target protein, the biomolecule, or both molecules.

When used in connection with the methods described herein, long timescale molecular dynamics simulation can be used to model the dynamics of systems comprising, at least 1,000 atoms, at least 5,000 atoms, at least 10,000 atoms, at least 20,000 atoms, or 50,000 or more atoms. Molecular dynamics simulation can be used to model flexibility and conformational changes according to the methods described herein through a number of distinct time steps, however the use of molecular dynamics simulation according to the methods described herein is not limited to a particular timescale. Timescales that can be used for the long timescale molecular dynamics simulations described herein can be 1 ns or less, at least 1 ns, at least 5 ns, at least 10 ns, at least 20 ns, at least 40 ns, at least 60 ns, at least 80 ns, at least 100 ns, at least 200 ns, at least 400 ns, at least 600 ns, at least 800 ns, at least 1000 ns, or more than 1000 ns.

In certain aspects, molecular dynamics simulations suitable for use with the methods described herein can be suitable for simulating structure based computational biochemistry of a single molecule, a molecular event, or in certain aspects, the statistical properties of a plurality of molecules. For example, in certain embodiments, molecular dynamics simulation can be used to simulate the structure or movement of a single molecule or the structure or movement of a large collection of molecules of a target protein or target protein-biomolecule complex. In certain embodiments, molecular dynamics simulation can be used to determine the concentration of bound biomolecules in a state when interactions of a plurality of proteins and biomolecules are simulated.

In certain embodiments, the molecular dynamics simulation computations described herein can be physics based simulations, energy based simulations, or a combination thereof. When used in connection with the methods described herein, physics based molecular dynamics simulation calculations can use the laws of classical mechanics to predict structure on the basis of a mathematical model of the physics of a molecular system. Physics based simulation is performed by modeling at the atomic level wherein individual atoms or groups of atoms are represented as point bodies in an N-body system. The force on each particle can be calculated and numerical integration of Newtonian laws can be performed to predict the physical trajectory of each atom in the system as a function of time. In certain aspects, the physics based molecular dynamics simulations suitable for use with the methods described herein can be Monte Carlo methods, such as those which stochastically sample a system's potential surface energy. Physics based molecular dynamics simulations, when used in connection with the methods described herein, can be used to refine a model or can be applied on their own.

Energy based molecular dynamics simulations, when used in connection with the methods described herein, can be used to compute the free energy of a molecular system. As used herein, reference to a free energy can be reference to a property of an ensemble of states as well as the property of a single state of a system. In certain embodiments, a lower free energy of an ensemble of states will correlate with a higher probability that a molecular system will be found in the said ensemble of states at any given time. Such free energies can be computed by determining the sum of probabilities or all states in a given ensemble.

In certain embodiments, the energy based molecular dynamics simulation methods described herein can calculate forces exerted by and among the members of a simulated system (e.g., atoms, groups of atoms, or molecules), including, but not limited to, the function of the distance, properties (e.g., charge, polarizability, etc.), and relation (e.g., bound or unbound) of the members of a system. Thus, in certain embodiments, the molecular dynamics simulations described herein can comprise steps of simulating a conformational change of all or part of a starting conformation of a molecule or molecular structure of a complex towards a different conformation of said molecule or molecular structure when in a complex (e.g., when in complex with a biomolecule). Such changes can arise from changes to the positions of atoms or groups of atoms from their respective positions in a starting molecular structure of a molecule or complex towards their respective positions at the end of the simulation.

In certain embodiments, energy based molecular dynamics simulations, when used in connection with the methods described herein, can comprise molecular force field based functions, including, without limitation, empirical potentials, semi-empirical potentials, polarizable potentials, pair potentials, many-body potentials or any combination thereof. The forces exerted upon atoms or groups of atoms in a molecular dynamics simulation can be from external or internal sources. Examples of internal sources include, but are not limited to, mutual interactions and influences between the members (e.g., atoms, groups of atoms, or molecules) of a molecular dynamics simulated system. Examples of external forces include those that can arise from supplemental forces introduced upon a structure including, for example, from binding of one or more additional molecules, or user selected forces inputted into a molecular dynamics simulation. In certain embodiments, energy based molecular dynamics simulation methods can calculate the potential energy of the system as a whole for a given molecular system or the force on each particle within a given system arising from the interactions of each particle with the rest of the system.

Energy based molecular dynamics simulations suitable for use with the methods described herein can also comprise a force field component to model molecular systems at the atomic level. In certain embodiments, the atoms or groups of atoms of a molecular system in a force field molecular dynamics simulation can be represented as one or more point bodies wherein each point body can be assigned one or more parameters, including, but not limited to, a mass, a charge, or, in certain embodiments, a partial charge (for example, an electron distribution caused by atomic bonding can be modeled with point charges). Parameters assigned to point bodies in a molecular force field molecular dynamics simulation can be determined at the outset of a simulation and can be kept constant throughout the simulation or can change as the simulation progresses. In certain embodiments, the parameter of a point body can depend on the identity of other particles near it and the identity of other atoms that may be bonded to it. In certain embodiments, the molecular dynamics simulation algorithms used in connection with the methods described herein can compute the formation of a bond between two atoms as a partial charge. This partial charge can be different than the charge that arises when a hydrogen atom is bonded to an oxygen atom. Thus the parameters of a point body can be different in the case of bonds between different atoms such as hydrogen atoms, carbon atoms, oxygen atoms, nitrogen atoms and so forth. Accordingly, one of skill in the art will understand that a set of point bodies and the parameters selected for each point body can affect the characteristics of a given force field.

Interactions between atoms in a molecular force field molecular dynamics simulation can also be divided into a plurality of components. One aspect of the interactions between atoms in a molecular force field molecular dynamics simulation can relate to the nature of the interaction between two atoms. For example, certain atoms interacting through a covalent bond can be modeled as a harmonic oscillator. A covalent bond modeled as a harmonic oscillator can model the tendency of two atoms interacting through a covalent bond to settle at a given distance from one another. This distance can be referred to as the bond length between two covalently bound atoms. Another aspect of covalent interactions between two atoms can be a function of the tendency of two bonds to bend towards a certain angle. Yet another aspect of covalent interactions between two atoms can be a function of the torsion or twisting of a bond between the atoms. Such twisting can arise from the relative angles the bond makes as a result of two bonds on either side of it.

Atoms in a force field model molecular dynamics simulation can also be affected by non-bonding forces. For example, electrostatic interaction charges that either cause attraction or repulsion among or between two or more atoms can be modeled, for example, according to Coulomb's law. Another non-bonding force that can be modeled in the molecular dynamics simulations described herein can be van der Waals interactions between two or more atoms. Van der Waals interactions are generally shorter range interactions relative to electrostatic interactions and can comprise an attractive or a repulsive component. At short distances, such as distance of 10⁻¹⁰ meters, the repulsive component of van der Waals forces will dominate. The attractive component of van der Waals forces can be modeled as reducing at the inverse sixth power of the distance between two particles.

Examples of the changes that can be simulated with the molecular dynamics simulation algorithms described herein include, but are not limited to, simulating conformation changes of one or more side-chain dihedral angles in a structure, or changes of the translational and rotational degrees of freedom of an object in a given space. The translational and rotational degrees of freedom of an object may thus be expressed in terms of the object's position and orientation in a space.

In certain aspects, the molecular dynamics simulation methods suitable for use with the methods described herein can further comprise calculation of restraints on conformational flexibility, including, for example, dihedral restraints, position restraints including linear position restraints and/or harmonic position restraints, and conformational restraints, simultaneously or sequentially in any suitable order. Restraints that can be used in connection with the molecular dynamics simulations described herein include restrictions on the position of a member (e.g., an atom, group of atoms, or molecule) of an molecular dynamics simulation as well as restraining one or more positions of a member as an absolute coordinate (value or range), as a function of a coordinate system, or as a coordinate (value or range) relative to one or more other members of the system.

In certain aspects, the molecular dynamics simulations described herein can comprise pairwise interaction calculations for particles. Such pairwise interactions can be calculated using a number of different methods, including, but not limited to, mid-point and neutral-territory methods (Shaw, Proceedings of the 34th Annual International Symposium on Computer Architecture, 2007; Bowers et al., J. Chem. Phys 2006, 24, 184109; Bowers et al., J. Phys.: Conf. Series 2005, 16, 300-304; M. Snir, Theor. Comput. Syst., 37: 295-318, 2004; Plimpton and Hendrickson, J. Comput. Chem., 17(3): 326-337, 1996; see also U.S. Pat. No. 7,707,016 to Shaw and U.S. Pat. No. 8,126,956 to Bowers, et al.). Such mid-point and neutral-territory methods are, in certain respects, hybrids between traditional spatial decompositions and the force decomposition methods. The pairwise interactions can be calculated by computing interactions between all pairs of particles, or alternatively by computing interactions only between pairs separated by less than a predefined interaction radius (near interactions). Thus, simulation can be performed by computing only near interactions or both near and distant interactions (i.e., interactions that occur over distances greater than the predefined interaction radius.

Serial or parallel processing methods can be used to compute any of the molecular dynamics simulations used in connection with the methods described herein. Many methods for parallel processing are known in the art, including atom, force, and spatial decomposition methods. See, for example, Heffelfinger, “Parallel atomistic simulations,” Computer Physics Communications, vol. 128. pp. 219-237 (2000), and Plimpton, “Fast Parallel Algorithms for Short Range Molecular Dynamics,” Journal of Computational Physics, vol. 117. pp. 1-19 (March 1995).

The molecular dynamics simulation can employ spatial decomposition algorithms in connection with the methods described herein. In certain embodiments, spatial decomposition can be used to consider pairs of nearby particles as opposed to considering all pairs in a system. In certain embodiments, a combination of spatial and force decomposition methods can be used in connection with the methods described herein. See, for example, Snir Theory Comput. Systems 37, 295-318, 2004 and Shaw, J Comput. Chem. 2005 October; 26(13):1318-28. In certain aspects, combining spatial and force decomposition can reduce the number of required communication between processors as a function of a decrease in interaction radius. The type of molecular dynamics simulation used in connection with the methods described herein can depend on a number of factors, including the physical system to be simulated (e.g., system dimensions, interaction radius) and the hardware available for the simulation (e.g., number of nodes, network topology, and memory structure including cache structure and sharing between nodes).

Molecular dynamics simulation methods suitable for use with the methods described herein also include Ewald summation methods (Ewald, P. Ann. Phys. 1921, 369, 253-287). These methods generally employ calculations that sum interaction energies in real space with an equivalent summation in Fourier space to compute interaction energies of periodic systems (e.g., crystals) and can be used to compute long range electrostatic force terms in molecular dynamics simulations. Derivations of traditional Ewald methods, such as the smoothed particle-mesh Ewald summation (SPME) and Gaussian split Ewald method (GSE) are also suitable for use with the methods described herein (Essman, et al., J. Chem. Phys. 1995, 19, 8577-8593; Shan, et al., J. Chem. Phys. 2005, 5, 54101-54113; see also U.S. Pat. No. 7,526,415 to Shan, et al.).

Other molecular dynamics simulation software packages or computer hardware that can be used in connection with the methods of the invention include, but are not limited to, Desmond (Bowers, et al., Proceedings of SuperComputing 2006, Tampa, US, 11-17 Nov. 2006), Blue matter (Fitch, et al., IBM RC23956, May 2006, 12), NAMD (Phillips et al., J. Comp. Chem. 2005, 26, 1781-1802), Gromacs4 (Hess, et al., J. Chem. Theor. and Comp. 2008, 4), Charmm (Brooks, et al., J. Comp. Chem. 1983. 4 (2): 187-217), Amber (Pearlman, et al., Comp. Phys. Commun, 1995, 91, 1-41), and specialized molecular dynamics hardware.

In certain embodiments, specialized molecular dynamics hardware can be a special purpose supercomputer such as, but not limited to, the Anton supercomputer (Shaw, et al., Proceedings of the 34th Annual International Symposium on Computer Architecture, 2007; see also U.S. Publication No. 20130091341 to Shaw, et al.) or the MD-GRAPE supercomputer (Komeiji, et al., J. Comp. Chem., 1997, 18, 1546-1563).

In certain embodiments, molecular dynamics simulation methodologies suitable for use with the methods described herein can comprise elements of semi-rigid-body docking algorithms. Specific molecular dynamics methods suitable for use with the methods described herein include, but are not limited to, “RosettaDock” (Gray et al. 2003 (J Mol Biol 331(1): 281-99)), as well as those described in J M Haile, 1997, “Molecular Dynamics Simulation: Elementary Methods”, Wiley-Interscience, 1.sup.st ed., ISBN: 047118439X; and D C Rapaport, 2004, “The Art of Molecular Dynamics Simulation”, Cambridge University Press; 2.sup.nd ed., ISBN: 0521825687. Other molecular dynamics methods suitable for use with the methods described herein include, but are not limited to, GROMACS (see, for example, Lindahl et al. 2001. Journal of Molecular Modeling 7: 306-317; Van Der Spoel et al. 2005. J Comput Chem 26: 1701-18; and Hess et al. 2008. J Chem Theory Comput 4: 435); GROMOS (see, for example, van Gunsteren et al., 1996, “Biomolecular Simulation: The GROMOS96 Manual and User Guide”, Vdf Hochschulverlag AG an der ETH Zurich, Zurich, Switzerland, pp. 1-1042); AMBER (see, for example, Case et al. 2005. J Computat Chem 26: 1668-1688; and Case et al., 2008, “AMBER 10”, University of California, San Francisco); and CHARMM (see, for example, Brooks et al. 1983. J Comp Chem 4: 187-217; and MacKerell et al., 1998, “CHARMM: The Energy Function and Its Parameterization with an Overview of the Program”, in The Encyclopedia of Computational Chemistry, 1.sup.st ed., John Wiley & Sons: Chichester, pp. 271-277). Semi-rigid dynamic docking algorithms can also be useful for simulation of side-chain repacking of protein binding partners to simulate conformational changes within proteins during an interaction.

Evolved Three Dimensional Topological Features

In certain aspects, the methods described herein relate to the identification of evolved three dimensional topological features using molecular dynamics simulation. The evolved three dimensional topological features can be transient or non-transient features of a target protein that arise as a result of biomolecular binding or as a result of modification of the target protein. In certain aspects, the volume and shape of an evolved three dimensional topological feature can have significance to the design of a small molecule capable of recognizing and binding to the evolved feature.

As used herein, an evolved three dimensional topological feature can be defined according to geometric descriptions of the depth, size, volume, and/or amino acid composition. In certain aspects, the evolved three dimensional topological feature can be nearly spherical or form a curved groove composed of several interconnected subpockets. In certain embodiments, the evolved three dimensional topological feature can be a catalytic site within a large and/or a deep cleft on the surface of a target protein. Non-limiting examples of evolved three dimensional topological features include, but are not limited to, grooves, hydrophobic pockets, cavities or clefts. The evolved three dimensional topological features can be within a target protein, on the surface of a target protein, or both within and on the surface of a target protein.

Although several kinds of algorithms for detecting and measuring pockets on proteins exist in the art, they can be divided into three broad categories, each of which are suitable for use with the methods described herein: geometric algorithms, energy-based methods, and precedence based methods. Algorithms that use combinations of geometric, energy, and/or precedence based methods are also suitable for use with the methods described herein. Non-limiting examples of methods for identifying and scoring evolved three dimensional features suitable for use in connection with the methods described herein are reviewed in Perot et al., Drug Discov Today. 2010 August; 15 (15-16):656-67.

Geometric algorithms can be used to assess pockets on proteins according to a variety of different methodologies. Some methods function by attempting to fit spheres into solvent-accessible pockets, whereas other geometric algorithms function by determining the interaction energy of a probe and distinct location on a target protein. Specific geometric based pocket diction algorithms suitable for use with the methods described herein include, but are not limited to, algorithms that rank predicted pockets by the degree of conservation of the closest surface residues such as LigSitecsc (Huang, B. and Schroeder, M. (2006), BMC Struct. Biol. 6, 19) and SURFNET-ConSurf (Glaser, F. et al. (2006) Proteins 62, 479-488), algorithms that identify pockets using the alpha-shape Principles such as APROPOS (Peters, K. P. et al. (1996) J. Mol. Biol. 256, 201-213), algorithms that define binding regions with sphere-based methods such as Binding-response (Peters, K. P. et al. (1996) J. Mol. Biol. 256, 201-213), algorithms that identify surface accessible pockets using the weighted-Delaunay triangulation and the alpha-shape principles such as CAST (Liang, J. et al. (1998) Protein Sci. 7, 1884-1897) and CASTp (Binkowski, T. A. et al. (2003) Nucleic Acids Res. 31, 3352-3355), algorithms that construct a three dimensional grid over a molecule such as CAVER (Petrek, M. et al. (2006) BMC Bioinformatics 7, 316), algorithms that cluster alpha-shape spheres, such as Fpocket (Le Guilloux, V. et al. (2009) BMC Bioinformatics 10, 168), algorithms that place probe spheres on the protein van der Walls surface such as GHECOM (Kawabata, T. and Go, N. (2007) Proteins 68, 516-529), algorithms that employ scanning along search vectors to define pockets such as LigSite (Hendlich, M. et al. (1997) J. Mol. Graph. Model. 15, 359-363), algorithms that identify pockets using Monte Carlo-based approaches such as McVol (Till, M. S. and Ullmann, G. (2009) J. Mol. Model. 16, 419-429), algorithms that fill cavities in a protein with a set of spheres such as PASS (Brady, G. P. and Stouten, P. F. (2000) J. Comput. Aided Mol. Des. 14, 383-401), algorithms that map protein surfaces with 3D grid and spherical probes such as POCKET (Levitt, D. G. and Banaszak, L. J. (1992) J. Mol. Graph. 10, 229-234), algorithms that divide cluster only the high-depth subspaces on a protein surface such as PocketDepth (Kalidas, Y. and Chandra, N. (2008) J. Struct. Biol. 161, 31-42), algorithms that identify clusters of grid points with a buriedness index such as PocketPicker (Weisel, M. et al. (2007) Chem. Cent. J. 1, 7), algorithms that identify empty spaces between the protein's molecular surface such as Screen (Nayal and Honig (2006) Proteins 63, 892-906), algorithms that identify the functional surface of the protein such as SplitPocket (Tseng, Y. Y. et al. (2009) Nucleic Acids Res. 37 (Web Server issue), W384-389; Tseng, Y. Y. and Li, W.-H. (2009) Proteins 76, 959-976), algorithms that fit spheres into solvent-accessible spaces such as SURFNET (Laskowski, R. A. (1995) J. Mol. Graph. 13, 323-330), algorithms that employ a coating a protein with a three dimensional grid such as TravelDepth (Coleman, R. G. and Sharp, K. A. (2006) J. Mol. Biol. 362, 441-458), algorithms that score grid points on a protein surface according to their degree of burial such as VICE (Tripathi and Kellogg (2010) Proteins 78, 825-842), algorithms that delineate cavities such as VOIDOO (Kleywegt and Jones (1994) Acta Crystallogr. D: Biol. Cryst. 50, 178-185), algorithms that apply geometric potentials for binding-site prediction such as the algorithm of Xie and Bourne (Xie and Bourne (2007) BMC Bioinformatics 8 (Suppl. 4), S9), or any combination thereof.

SCREEN (Surface Cavity REcognition and EvaluatioN), a geometry based method, has been used to estimate the average volume of a drug binding cavity to a volume of about 930 A°³ (Nayal and Honig, Proteins 63, 892-906). In certain embodiments, an evolved three dimensional topological feature identified according to the methods described herein will have a volume of at least about 50 A°³, at least about 100 A°³, at least about 150 A°³, at least about 200 A°³, at least about 300 A°³, at least about 400 A°³, at least about 500 A°³, at least about 700 A°³, at least about 900 A°³, at least about 930 A°³, at least about 1000 A°³, at least about 1200 A°³, at least about 1500 A°³, at least about 2000 A°³, or at least about 3000 A°³ as measured using SCREEN (Surface Cavity REcognition and EvaluatioN) (Nayal and Honig, Proteins 63, 892-906).

Energy based pocket prediction and detection methods are also suitable for use with the methods described herein. Energy based methods, which can incorporate physics into the process of pocket detection, include algorithms that calculate a Lennard-Jones potential over a grid of a protein such as Energy-based ICM-PocketFinder (An, J. et al. (2005) Mol. Cell. Proteomics 4, 752-761), algorithms that position probes at grid points along a protein surface to determine interaction energies such as Q-SiteFinder (Laurie and Jackson (2005) Bioinformatics 21, 1908-1916), algorithms that identify regions on a protein having favorable van der Waals interactions such as SITEHOUND (Ghersi and Sanchez (2009) Proteins 74, 417-424), algorithms that identify a contiguous envelope of a protein with the atoms having largest possible interaction energy with the protein such as AutoLigand (Harris, R. et al. (2008) Proteins 70, 1506-1517), algorithms that identify energetically favorable binding sites such as GRID (Goodford, P. J. (1985) J. Med. Chem. 28, 849-857), algorithms that coat a protein with a plurality of different kinds of probes such as Surflex-Protomol (Ruppert, J. et al. (1997) Protein Sci. 6, 524-533), algorithms that identify Binding sites via docking such as MEDock (Chang et al. (2005) Nucleic Acids Res. 33 (Web Server issue), W233-238), or any combination thereof.

PocketFinder, an energy-based approach, has been used to define the average envelope volume enclosing pockets was found to be about 610 A°³ (An, J. et al. (2005) Mol. Cell. Proteomics 4, 752-761). In certain embodiments, an evolved three dimensional topological feature identified according to the methods described herein will have a volume of at least about 50 A°³, at least about 100 A°³, at least about 150 A°³, at least about 200 A°³, at least about 300 A°³, at least about 400 A°³, at least about 500 A°³, at least about 610 A°³, at least about 700 A°³, at least about 900 A°³, at least about 930 A°³, at least about 1000 A°³, at least about 1200 A°³, at least about 1500 A°³, or at least about 2000 A°³ as measured using PocketFinder (An, J. et al. (2005) Mol. Cell. Proteomics 4, 752-761).

The evolved three dimensional topological features described herein can also be identified by using precedence based algorithms that compare structure information in a target protein to database of known binding pockets. Several such methods are known in the art and are suitable for use with the methods described herein. These structure based methods generally operate by local comparison of cavity regions of a target protein to unrelated proteins. Algorithms that can be used to identify evolved three dimensional topological features by evaluating binding site similarities with other proteins include, but are not limited to, algorithms that assess the physico-chemical properties of amino acid residue around a cavity and identify similarities in a database such as CavBase (Schmitt, S. et al. (2002) J. Mol. Biol. 323, 387-406), algorithms that employ sequence and structural alignment between binding sites such as CPASS (Powers, R. et al. (2006) Proteins 65, 124-135), algorithms that identify local structure features of proteins that share a common biochemical function such as CSC (Milik, M. et al. (2003) Protein Eng. 16, 543-552), algorithms that employ clique detection on a solvent-accessible surface such as eF-seek (Kinoshita, K. et al. (2002) J. Struct. Funct. Genom. 2, 9-22), algorithms that use threading to identify ligand binding sites across groups of weakly homologous template structures such as FINDSITE (Brylinski and Skolnick (2008) Proc. Natl. Acad. Sci. U.S.A. 105, 129-134), algorithms that use graph-matching to find pairwise three dimensional similarities such as IsoCleft (Najmanovich, R. et al. (2008) Bioinformatics 24, i105-i111), algorithms that recognize common spatial arrangements of physico-chemical properties in the binding sites with the application of geometric hashing such as MultiBind (Shulman-Peleg, A. et al. (2008) Nucleic Acids Res. 36 (Web Server issue), W260-264), algorithms that employ clique detection on binding sites transformed into graphs such as the algorithm of Park and Kim (Park, K. and Kim, D. (2008) Proteins 71, 960-971), algorithms that assess local similarities solvent-accessible surfaces such as PROSURFER (Minai, R. et al. (2008) Proteins 72, 367-381), algorithms that integrate a plurality of existing databases and programs for three dimensional functional annotation such as Query3d (Ausiello, G. et al. (2005) BMC Bioinformatics 6 (Suppl. 4), S5), algorithms that compare a target protein against the 3D structure of another protein in complex with a ligand such as the algorithm of Ramensky et al. (Ramensky, V. et al. (2007) Proteins 69, 349-357), algorithms that measure distances between protein cavities to define a cavity fingerprint such as SiteAlign (Schalon, C. et al. (2008) Proteins 71, 1755-1778), algorithms that use geometric matching to detect similar three-dimensional structure such as SiteBase (Brakoulias and Jackson (2004) Proteins 56, 250-260), algorithms that employ hashing and matching of triangles of centers of physico-chemical properties such as SiteEngine (Shulman-Peleg, A. et al. (2004) J. Mol. Biol. 339, 607-633), algorithms that structural domains from the CDD (Conserved Domain Database) that are in complex with small compounds such as SMID-BLAST (Snyder, K. A. et al. (2006) BMC Bioinformatics 7, 152), algorithms that compare triangles of chemical groups built from chemical groups of atoms such as SuMo (Jambon, M. et al. (2005) Bioinformatics 21, 3929-3930), algorithms that identify similarities between protein binding sites based and the chemical similarity of matching residues such as VA (McGready, A. et al. (2009) J. Mol. Model. 15, 489-498), algorithms that combine clique-detection and geometric hashing approaches such as the algorithm of Weskamp et al. (Weskamp, N. et al. (2007) IEEE/ACM Trans. Comput. Biol. Bioinform. 4, 310-320), algorithms that can be employed as a pipeline for comparative modeling of protein-ligand complexes such as @TOME-2 (Pons and Labesse (2009) Nucleic Acids Res. 37 (Web Server issue), W485-491), or any combination thereof.

In certain aspects, the evolved three dimensional topological features identified according to the methods described herein can be scored with regard to small molecule or other specific optimization parameters. Non limiting examples of scoring functions are described in Teramoto and Fukunishi (2008) J. Chem. Inf. Model. 48, 288-295; Feher, M. (2006) Drug Discov. Today 11, 421-428; and Seifert, M. H. et al. (2007) Curr. Opin. Drug Discov. Devel. 10, 298-307.

### Docking

The methods described herein also relate to methods for identifying one or more small molecules capable of binding to one or more evolved three dimensional topological features in a protein, such as those three dimensional topological features that evolve in a molecular dynamics simulation.

Methods of screening small molecules in a laboratory setting for a desired effect on a target protein as indicated by experimental results are known in the art. However such approaches can be laborious and time consuming because analysis of potentially millions of different molecules (or even more) can be required. Identification of small molecules capable of binding to an evolved topological feature can be performed according to any method known in the art, including, but not limited to, in-silico methods. Thus, small molecules can be rationally designed using in silico methods by generating small molecules that bind to three dimensional topological features. Such in silico computation can be useful for selecting molecules that have a desired effect on a target protein through the use of rational small molecule design. Rational small molecule design strategies can be used to produce binding orientations for a small molecule within a site on a target protein and to determine the energetic compatibility of the small molecule and the target protein based on a number of criteria, including, inter alia, lipophilic interactions, hydrogen bonding, repulsion between atoms, and intramolecular strain.

In-silico methods suitable for identifying small molecules that bind to an evolved three dimensional topological feature include docking algorithms suitable for predicting protein interactions with small molecules. Such in-silico methods also include methods for rational small molecule design that use structural information about drug targets and their natural ligands for the design of candidate small molecules. Although specific rational small molecule design docking algorithms differ by specific methodology, such approaches can use a three-dimensional model of the structure for the target protein, for example a three dimensional structure comprising an evolved three dimensional topological feature, such as those identified according to the methods described herein. The three dimensional model of the structure for the target protein can also be obtained from X-ray crystallography, NMR, homology modeling, analysis of protein motifs and conserved domains, and/or computational modeling of protein folding and conformational change(s).

Docking algorithms capable of computational modeling of target-small molecule complexes can involve large-scale in-silico screening of compound libraries (i.e., library screening). In certain embodiments, the libraries can be virtually generated and stored as one or more compound structural databases. Rational small molecule design algorithms suitable for use with the methods described herein can also incorporate lead optimization and considerations of desired drug-like biological properties. Thus, in certain embodiments, the small molecule libraries can be constructed via combinatorial chemistry, using computational methods to rank selected subsets of small molecules based on computational prediction of bioactivity (or an equivalent measure) with respect to the intended target protein. The small molecules can be filtered on the basis of predicted drug like properties. Exemplary drug like properties include, but are not limited to, the degree of bioavailability of the ligand, water solubility of the ligand, molecular size of the ligand, stability of the small molecule, toxicity of the small molecule, or any combination thereof. Many algorithms for predicting whether a candidate ligand has drug like properties include those reviewed in Walters and Murcko, Adv Drug Deliv Rev. 54(3): 255-71, 2002 and Walters et al., Curr Opin Chem Biol. 3(4): 384-7, 1999). Specific algorithms useful for predicting whether a candidate small molecule has drug like properties suitable for use with the methods described herein include, but are not limited to, Rapid Elimination of Swill program (REOS) (Walters et al., Drug Disc Today 3:160-178, 1998).

In certain embodiments, the small molecules identified according to the methods described herein can bind to a three dimensional topological feature that evolves at a location on a target protein that is different than a known or natural protein-ligand interaction interface. In certain embodiments, the small molecules identified according to the methods described herein can bind to a three dimensional topological feature that evolves at a location on a target protein that overlaps with the known protein-ligand interaction interface. In certain embodiments, the small molecules identified according to the methods described herein can bind to a three dimensional topological feature that evolves at a location on a target protein that is the same as the known protein-ligand interaction interface.

Where computational modeling is used in connection with the methods described herein, binding predictions can be performed in two steps. In a first docking step, the computational system attempts to predict the optimal “binding mode” for the small molecule to an evolved three dimensional topological feature on a target protein. A second “scoring” step involves computation and refining the estimate of the binding affinity associated with the computed binding of the small molecule and the evolved three dimensional topological feature.

As used herein, the term “binding mode” refers to the three dimensional molecular structure of a potential molecular complex between a target protein and candidate small molecule in a bound state at or near a minimum of the binding energy (i.e., maximum of the binding affinity). The term “binding energy” refers to the change in free energy of a target protein-small molecule system upon formation of a complex, i.e., the transition from an unbound to a (potential) bound state for the small molecule and target. Where the binding energy is small, the concentration of the ligand required to cause a biological effect in vivo may be too high for practical therapeutic purposes. Thus, the binding free energy of a given protein-ligand pair correlates to molecular complex formation between the protein-ligand pair in chemical equilibrium and modification of one or more characteristics of the ligand can be performed to improve potency, binding specificity, or other properties of the ligand.

Binding affinity, which is conceptually counter to “binding energy”, can be useful for rational small molecule design in connection with the methods described herein and can be an indicator of how well a drug candidate will serve its purpose. Methods for determining such properties include algorithms suitable for determining the free energy difference between the unbound and bound states of a system. As used herein, the term free energy refers to both enthalpic and entropic effects as the result of physical interactions between the constituent atoms and bonds of the molecules between themselves (i.e., both intermolecular and intramolecular interactions) and with their surrounding environment.

Many different docking algorithms suitable for use with the methods described herein exist in the art (see, e.g., Voigt et al. 2000. J Mol Biol 299: 789-803). As used herein, a docking algorithm is a computational process of assembling two or more separate constituents into a complex structure. Docking programs that perform docking through side-chain packing simulation are also suitable for use with the methods described herein. As used herein, the term “side-chain packing” refers to the computational process of predicting side-chain geometries for known backbone conformations. In some embodiments, docking algorithms that use side-chain packing can identify minimum energy side-chain conformations.

Suitable docking algorithms include those that use rigid-body pattern-matching algorithms (for example, those that use surface correlations, geometric hashing, pose clustering, or graph pattern-matching), fragmental-based methods (for example, incremental construction or place and join operators), stochastic optimization methods (for example, Monte Carlo, simulated annealing, or genetic algorithms), molecular dynamics simulations, simulated annealing methods, restricted combinatorial analysis methods, self-consistent mean field (SCMF) methods, graph theory-based methods (Canutescu et al. 2003. Protein Sci 12: 2001-2014), dead-end elimination (DEE) methods (Desmet et al. 1992. Nature 356: 539-542; Pierce et al. 2000. J Comput Chem 21: 999-1009), and “fast and accurate side-chain topology and energy refinement” (FASTER) methods (Desmet et al. 2002. Proteins 48: 31-43; WO 01/33438), graph-based pattern-matching algorithms (Lawrence et al., Proteins, Vol. 12, 31-41 (1992); Kastenholz et al., J. Medicinal Chemistry, Vol. 43, 3033-3044 (2000); Miller et al., J. Computer-Aided Molecular Design, Vol. 8 No. 2, 153-174 (1994); Sobolev, Proteins, Vol. 25, 120-129 (1996)) shape-based correlation methods (Aloy et al., Proteins: Structure, Function, and Genetics, Vol. 33, 535-549 (1998); Ritchie et al., Proteins: Structure, Function, and Genetics, Vol. 39, 178-194 (2000)), geometric hashing (Fischer et al., Proteins, Vol. 16, 278-292 (1993)), pose clustering (Rarey et al., J. Computer-Aided Molecular Design, Vol. 10, 41-54 (1996)), graph-based rigid-body pattern-matching algorithms (Shoichet, et al, J Comp Chem, Vol. 13 No. 3, 380-397 (1992); Meng, et al., Proteins: Structure, Function, and Genetics, Vol. 17, 266-278 (1993); Ewing, et al., J. Computational Chemistry, Vol. 18 No. 9, 1175-1189 (1997)), or combinations thereof. In certain embodiments, rigid-body pattern-matching algorithms can be used for de novo ligand design, combinatorial library design, or straightforward rigid-body screening of a molecule library containing multiple conformers per ligand where docking small, rigid small molecules to a simple protein with a well-defined, nearly rigid active site is useful. Another docking algorithm suitable for use with the methods described herein is Glide SP 2008 (Schrodinger Inc). For example, Glide SP 2008 can be used on a virtual chemical library of compounds stocked in the Small Molecule Discovery Center of UCSF. Virtual chemical libraries for use with the docking algorithms described herein can be from any known database or method of preparation known in the art, including, but not limited to chemical libraries prepared using Ligprep 2008 (Schrodinger Inc).

In certain embodiments, docking algorithms that account for the flexibility/rotatability of bonds can ensure the complete sampling of binding interactions. Docking algorithms that evaluate ligands within a 3-D structure of a macromolecule using force field functions are also suitable for use the methods described herein (Kollman, Chem Rev. 2395-2417, 1993; Brooks et al., J Comput Chem. 4:187-217, 1983).

Specific docking algorithms suitable for use with the methods described herein include, but are not limited to, “DOCK” (Meng, et al., J. Comp. Chem. 13: 505-524, 1992; Ewing and Kuntz, Prot Engin. 18: 1175-1189, 1993), “Autodock” (Molecular Graphics Laboratory), FlexX (Tripos, Inc., St. Louis, Mo.), “Gold” (Jones et al., J. Mol. Biol. 267(3): 727-48, 1997), FlexiDock (Tripos, Inc.), “GAMBLER” (Charifson et al., J Med Chem. 42:5100-5109, 1999), “CAPRI” (Janin et al. 2003. Proteins 52 (1): 2-9; Mendez et al. 2005. Proteins 60: 150-169; http://www.ebi.ac.uk/msd-srv/capri/), “RosettaDock” (Gray et al. 2003. J Mol Biol 331: 281-99), ‘ClusPro’ (Comeau et al. Bioinformatics 20: 45-50), “GRAMM-X” (Tovchigrechko and Vakser. 2006. Nucleic Acids Res 34: W310-4), “FireDock” (Andrusier et al. 2007. Proteins 69: 139-59), “HADDOCK” (Dominguez et al. 2003: J Am Chem Soc 125: 1731-1737), “PatchDock” (Schneidman-Duhovny et al. 2005. Nucl Acids Res 33: W363-367), “SKE-DOCK” (Genki Terashi et al. 2005. Proteins 60: 289-95), and “3D-Garden” (Lesk and Sternberg. 2008. Bioinf: doi: 10.1093/bioinformatics/btn093).

In certain embodiments, docking algorithms suitable for use with the methods described herein can be incremental construction based docking software tools such as FlexX (Kramer et al, Proteins, Vol. 37, 228-241 (1999); Rarey et al., J. Mol. Biol., Vol. 261, 470-489 (1996)) or Hammerhead (Welch, et al., Chemical Biology, Vol. 3, 449-462 (1996)), nongreedy, backtracking algorithms (Leach, et al, J. Comp. Chem., Vol. 13, 730-748 (1992)), and programs using incremental construction in the context of de novo ligand design (Bohm, J. Computer-Aided Molecular Design, Vol. 6, 61-78 (1992); Bohacek and McMartin, J. American Chemical Society, Vol. 116, 5560-5571 (1994)). Also suitable for use with the methods described herein are docking algorithms that employ “place and join” strategies methodologies (DesJarlais et al., J. Med. Chem., Vol. 29, 2149-2153 (1986)). Docking algorithms that use stochastic optimization are also suitable for use with the methods described herein (see Abagyan, et al., J. Comp. Chem., Vol. 15, 488-506 (1994); Halgren, et al., J Med Chem., Vol. 47 No. 7, 1750-1759, (2004); Luty, et al., J. Comp. Chem., Vol. 16, 454-464 (1995); Goodsell, et al., Proteins: Structure, Function, and Genetics, Vol. 8, 195-202 (1990); Jones, et al, J. Mol. Biol., Vol. 245, 43-53 (1995); Jones, et al., J. Mol. Biol., Vol. 267, 727-748 (1997); Taylor and Burnett, Proteins, Vol. 41, 173-191 (2000); Morris et al., J. Comp. Chem., Vol. 19, 1639-1662 (1998)).

Scoring

Scoring of the complex formation between a target protein and a candidate small molecule can be performed according a variety of methods, including, but not limited to, heuristic, deterministic, or stochastic scoring functions. One of skill in the art will understand that the number of configurations of the one or more small molecule candidates can be reduced by maintaining the evolved three dimensional topological feature in a rigid state, however this restriction is not required. In certain embodiments, the biomolecules can be assayed in silico in various poses and orientations at various points in proximity to the evolved three dimensional topological feature on the target protein. Although scoring functions can be useful for identifying small molecule candidates capable of binding to an evolved three dimensional topological features, heuristic algorithms may not necessarily be useful for prediction of other properties of a small molecule candidate-target protein interaction including, for example, the concentration of a biomolecule capable of affecting a function of the protein. In certain embodiments, different scoring functions can be combined to form combinatorial scoring methodologies.

Scoring functions can be used in combination with docking programs to evaluate protein-small molecule models based on a variety of parameters, including, but not limited to, residue contacts, shape, and/or chemical complementarity, or combinations thereof. Such scoring functions can be used to estimate target-biomolecule affinity, rank prioritize different biomolecules as per a library screen, or rank intermediate docking poses in order to predict binding modes. In certain aspects, stochastic optimization can be used to model docking of flexible biomolecules to a target molecule. Stochastic optimization can employ various strategies to search for one or more favorable system energy minima.

A number of different scoring functions are suitable for use with the methods described herein, including, but not limited to, empirical scoring functions, molecular-mechanics-based expressions, knowledge-based scoring functions, or combinations thereof. Empirical scoring functions that can be used to calibrate empirical energy models, wherein each energy model is multiplied by an associated numerical weight and wherein each represents one of a set of interaction components in a master scoring equation. Fitting to experimental binding free energy data of a training set of target-biomolecule complexes can be used to obtain numerical weight factors. Exemplary empirical scoring functions suitable for use with the methods described herein include, but are not limited to, SCORE (Wang et al., J. Molecular Modeling, Vol. 4, 379 (1998)), ChemScore (Eldridge et al., J. Computer-Aided Molecular Design, Vol. 11, 425-445 (1997)), PLP (Gelhaar, et al, American Chemical Society: Washington, D.C., pp. 292-311 (1999), Fresno (Rognan et al., J. Medicinal Chemistry, Vol. 42, 4650-4658 (1999) and GlideScore v.2.0+ (Halgren et al., J Med Chem., Vol. 47 No. 7, 1750-1759 (2004).

Molecular-mechanics-based scoring functions suitable for use with the methods described herein can be chemical- or energy-based scoring functions, objective functions, or scoring functions developed for molecular mechanics force fields (Cornell, J. American Chemical Society, Vol. 117, 5179-5197 (1995); Jorgensen and Tirado-Rives, American Chemical Society, Vol. 110, 1657-1666 (1988); Halgren, J. Comp. Chem., Vol. 17, 490-519 (1996); Brooks et al., J. Comp. Chem., Vol. 4, 187-217 (1983)). Molecular-mechanics-based scoring functions can employ atomic level attributes (e.g., charge, mass, vdW radii, bond equilibrium constants, etc.) based on one or more molecular mechanics force fields including both intramolecular interactions (i.e., self-energy of molecules) and long range interactions (e.g. electrostatics) (Stewart, Quantum Chemistry Program Exchange, Vol. 10:86 (1990); Liotard et al., Quantum Chemistry Program Exchange—no. 506, QCPE Bulletin, Vol. 9: 123 (1989); AMSOL—version 6.5.1 by G. D. Hawkins et al., University of Minnesota, Minn. (1997).

Knowledge-based scoring functions suitable for use with the methods described herein include mean force statistical mechanics methods (Gohlke, J. Mol. Biol., Vol. 295, 337-356 (2000); Muegge and Martin, J. Med. Chem., Vol. 42, 791-804 (1999); Mitchell et al., J. Comp. Chem., Vol. 20, 1165-1176 (1999). Hybrid scoring functions are also suitable for use with the methods described herein. Examples of such functions include, but are not limited to, those described in Head et al., J. American Chemical Society, Vol. 118, 3959-3969 (1996) and Bissantz et al., J Med Chem, Vol. 43, 4759-4767 (2000).

Examples of scoring functions suitable for use with the methods described herein include, but are not limited to, DOCK energy score (Meng et al., J. Comp. Chem. 13: 505-524, 1992; Ewing and Kuntz, J. Comput. Chem. 18:1175-1189, 1997), DOCK contact score (Shoichet et al., J. Comput. Chem. 13:380-397, 1992), DOCK chemical score, ChemScore (Murray et al., J. Comput.—Aided Mol. Des. 12:503-19, 1998; Eldridge et al., J. Comput.—Aided Mol. Des. 11:425-45, 1997), Piecewise Linear Potential (PLP; Gehlhaar et al., Chem. Bio. 2:317-324, 1995), Bohm (Bohm, H.-J., J. Comput.—Aided Mol. Des. 6:61-78, 1992), FLOG (Miller et al., J. Comput.—Aided Mol. Des. 8:153-174, 1994), Merck Molecular Force Field non-bond energy (MFF; Halgren, J. Comput. Chem. 17:553-586, 1996; Halgren, J. Comput. Chem. 17:520-552, 1996; Halgren, J. Comput. Chem. 17:490-519, 1996), Buried Lipophilic Surface Area (Flower, J. Mol. Graphics Modell. 15:238-244, 1998), Poisson-Boltzman (Honig and Nicholls, Science 268:1144-9, 1995), the OPLS all-atom force field (Jorgensen et al., J Am Chem Soc. 118:11225-1123, 19966), and Volume Overlap (Stouch and Jurs, J. Chem. Inf. Comput. Sci. 26:4-12, 1986), Smith and Sternberg 2002. Curr Opin Struct Biol 12: 28-35; Camacho and Vajda 2002. Curr Opin Struct. Biol 12: 36-40; Halperin et al. 2002. Proteins: Struct Funct Genet 47: 409-443).

Small molecules that bind to the evolved three dimensional structures described herein can also be identified by in silico superpositioning techniques. Superpositioning refers to spatial positioning and modeling candidate small molecules with protein targets through manipulation of three dimensional structural data to superimpose related structures. Superpositioning can be performed in connection with the methods described herein using algorithms that assess rigid-body, semiflexible, and flexible small molecules conformations (see generally, Lemmen and Lengaur, J Comp-Aided Molec Des. 14:215-232, 2000). Superpositioning can also be performed by overlaying atoms related by sequence homology or shared fold (Guex and Peitsch, Electrophoresis 18:2714-2723, 1997; Holm, and Sander, Mol. Biol. 233:123-138, 1993), or by overlaying side chains or functional groups (Russell, R. B., J. Mol. Biol. 279:1211-1227, 1998; Schmitt et al., J. Mol. Biol. 323:387-406; 2002). Atoms that can be overlaid for superimposition can be identified with a number of different resources, including but not limited to, Combinatorial Extension (Shindyalov and Boume, Protein Engin., 11(9): 739-747, 1998), VAST (Madej et al., Proteins 23:356-369, 1995); and DEJAVU (Kleywegt and Jones, Meth Enzymol. 277:525-545, 1997); MOE (Chemical Computing Group, Inc.); Swiss Pdb Viewer (Guex and Peitsch, Electrophoresis 18:2714-2723, 1997); and WebLab ViewerPro (Accelrys Inc., San Diego, Calif.).

There are a number of superpositioning programs suitable for use with the methods described herein including, but not limited to, algorithms that are useful for creating three dimensional representations of molecules from two dimensional information such as CONCORD (Tripos Inc., St. Louis, Mo.) and CORINA (Gasteiger et al., Tetrahed Comp Meth. 3: 537-547, 1990; Gasteiger et al., J. Chem. Inf. Comput. Sci. 36:1030-1037, 1996). Other superpositioning programs that can be used in connection with the methods described herein include MOE (Chemical Computing Group, Inc.) and ProFit (UK HGMP Resource Centre).

Small molecules capable of binding to the evolved three dimensional topological features identified according to the methods described herein can also be docked to the target protein through query model generation. Candidate small molecules can be virtually docked to an evolved three dimensional topological feature and evaluated for compatibility with the target protein.

Pharmacophore-based strategies can also be used to identify small molecules according to the methods described herein. As used herein, the term pharmacophore refers to a configuration of the substituents of a small molecule that confer biochemical or pharmacological effects. The pharmacophore can be a user-generated model of structures from a library of small molecules having chemical properties suitable for drug development. Such properties include bioavailability, hydrogen-bond or other non-covalent binding association, electrostatic interactions, chemical functional group positioning for binding interaction, solubility and the like. Pharmacophores can also be generated from a model of a compound that has demonstrated a desirable activity in an experimental assay or from structural information of a molecule that regulates an activity of the target protein or a protein that is related in structure or sequence to the target protein (e.g., a polypeptide encoded by a member of the same gene family).

The pharmacophore for a small molecule screen can be performed by identifying atoms involved in bonding (for example, hydrogen bonding) to an evolved three dimensional topological feature of the target protein. Programs suitable for identifying such bonds are known in the art and include, but are not limited to, WebLab ViewerPro (Version 4.0) and DeepView Swiss-PDB Viewer (http://www.expasy.org/spdbv/; Guex, and Peitsch. Electrophor. 18:2714-2723, 1997). See also Pierce et al., Proteins 49:576-576, 2002. A model of the pharmacophore can then be generated by connecting the atoms involved in bonding to the evolved three dimensional topological feature.

A model of the candidate small molecule can be generated by placing the pharmacophore within the evolved three dimensional topological feature and progressively or iteratively attaching chemical groups to the pharmacophore. Identification of pharmacophore can be performed manually or with the use of software, for example, OEChem. The coordinates of the pharmacophore of a small molecule can then be transferred to a candidate small molecule, and any remaining atoms in the candidate small molecule can be assigned arbitrary atomic coordinates. Constrained minimization can then be performed by freezing atoms in the candidate small molecule that have corresponding atoms in the small molecule pharmacophore. Constrained minimization can be performed using any method available in the art, including, but not limited to, Quanta, MOE, Sybyl, and Maestro algorithms. The candidate small molecule can then be combined with the target protein and minimum energy conformations for the candidate small molecule in complex with an evolved three dimensional topological feature on the target protein can be determined Minimum energy conformations of the candidate small molecule can be determined for the atoms on the candidate small molecule previously assigned arbitrary coordinates. Methods for searching and for scoring minimum energy conformations for candidate small molecules exist in the art. One non-limiting example is through restricted modeling. Restricted modeling can be performed by first defining dihedral bonds between the framework/substructure as fixed and bonds between other atoms of the candidate small molecule can be defined as flexible. Conformational searching can then be performed to model potential three dimensional conformations for the bonds outside of the framework/substructure of the candidate small molecule can be obtained from a torsion library (e.g., the Omega torsion library) to generate a plurality of conformers of the candidate small molecule. The energy of each conformer can then be calculated with a force field. Additional refinement can be performed according to any method known in the art. For example, refinement can be performed using rigid body minimization until such point as the empirical scoring function of the rigid body minimization ceases to change (e.g., at a convergence criterion of 0.001 ChemScore units). See, for example, Di Nola et al, Proteins, Vol. 19, 174-182 (1994). Alternatively, refinement can be performed by rigid-body pattern-matching followed by Monte Carlo torsional optimization. Molecular dynamics can also be performed to refine small molecule structures (Wang et al., Proteins, Vol. 36, 1-19 (1999)). Other methods for defining pharmacophores in connection with the methods disclosed herein are described in Cormen et al. Intro to Algorithms, MIT Press, Cambridge, 1990, pp. 447-485; Hansen, P. J. Chemical Applications of Graph Theory J Chem Ed. 65:574-580, 1988; Bemis and Kuntz, J Comp-Aided Mol Des. 6:607-628; 1992; Nilakantan, et al., J Chem Inf Comput Sci. 27: 82-85, 1987).

Modulation

In certain aspects, described herein are methods useful for identifying small molecules which are capable of modulating the activity of a target protein wherein the small molecule binds to an evolved three dimensional topological feature of the target protein. Modulation of the activity of a target protein can take many forms including, but not limited to, activation, deactivation, catalysis, inhibition, localization, stability, interaction profile, specificity, or any combination thereof of the target protein. As used herein, modulation by a small molecule refers to either an increase or decrease of any activity of a target protein contacted by the small molecule by, for example, at least about 1%, at least about 5%, at least about 10%, at least about 20%, at least about 30%, at least about 40%, at least about 50%, at least about 75%, at least about 100%, at least about 200%, at least about 500%, or at least about 1000% relative to a target protein that has not been contacted with the small molecule. In certain aspects, the modulation of the activity of the target protein can be in the presence of a biomolecule that also contacts the target protein. In certain aspects, the modulation of the activity of the target protein can be in the absence of a biomolecule that also contacts the target protein.

As used herein, when a small molecule modulates the activity of a target protein by decreasing an activity of the target protein, non-limiting examples of decreasing an activity can be a block, decrease, prevention, delay activation, or desensitized activation, stimulation, binding, or localization of or by the target protein. As used herein, when a small molecule modulates the activity of a target protein by increasing an activity of the target protein, non-limiting examples of increasing an activity can be stimulation, increase, activation, facilitation, sensitization, binding, or localization of or by the target protein. Specific examples of activities that can be modulated with the small molecules identified according to the methods described herein include, but are not limited to, an activity of a protein (e.g., phosphorylation of a substrate, proteolysis of a substrate) and/or of a protein-mediated pathway (e.g., stimulation of cell division by a kinase mediated pathway, HIV protease-dependent infectivity), binding of the target protein, a change in the binding of the target protein to a substrate or interaction partner, localization of a target protein (e.g., a transcription factor that changes localization upon activation), modification of the target protein (e.g., phosphorylation, acetylation), modification of a substrate of a target protein (e.g., phosphorylation of a kinase substrate, activation of transcription of a nucleic acid by a transcription factor), or any combination thereof.

Activity of the small molecules identified according to the methods described herein can be assayed according to any method known in the art. For example, a small molecule identified according to the methods described herein can be assessed for the ability to bind to a target protein, either in the presence or absence of a biomolecule (or in the presence or absence of a modification of the target protein) using cell-free and cell-based methods known in the art (e.g., in vitro methods, in vivo methods, or ex vivo methods). For example, an isolated target protein or target protein-biomolecule complex can be employed, or a cell can be contacted with the candidate molecule and the target protein or target protein-biomolecule complex can be isolated from such contacted cells and the target protein or target protein-biomolecule complex can be assayed for activity or component composition. Methods for screening can involve labeling the component of the target protein or target protein-biomolecule complex with, for example, radioligands, fluorescent ligands, or enzyme ligands. Target proteins or target protein-biomolecule complexes can be isolated by any technique known in the art, including but not restricted to, co-immunoprecipitation, immunoaffinity chromatography, size exclusion chromatography, and gradient density centrifugation.

The methods descried herein can be applied to any target protein or target protein-biomolecule complex of interest, including, without limitation, protein kinases, nuclear hormone receptors, ion channels, G-protein coupled receptors, phosphatases, and proteases, and nucleic acids such as DNA, RNA, ribozymes, etc. Specific non-limiting examples of target proteins or biomolecules include, but are not limited to, amyloid protein and amyloid precursor protein; anti-angiogenic proteins such as angiostatin, endostatin, METH-1 and METH-2; apoptosis inhibitor proteins such as surviving; clotting factors such as Factor IX, Factor VIII, and others in the clotting cascade; collagens; cyclins and cyclin inhibitors, such as cyclin dependent kinases, cyclin D1, cyclin E, WAF1, cdk4 inhibitor, and MTS1; cystic fibrosis transmembrane conductance regulator gene (CFTR); cytokines such as IL-1, IL-2, IL-3, IL-4, IL-5, IL-6, IL-7, IL-8, IL-9, IL-10, IL-11, IL-12, IL-13, IL-14, IL-15, IL-16, IL-17 and other interleukins; hematopoetic growth factors such as erythropoietin (Epo); colony stimulating factors such as G-CSF, GM-CSF, M-CSF, SCF and thrombopoietin; growth factors such as BNDF, BMP, GGRP, EGF, FGF, GDNF, GGF, HGF, IGF-1, IGF-2, KGF, myotrophin, NGF, OSM, PDGF, somatotrophin, TGF-.beta., TGF-.alpha. and VEGF; antiviral cytokines such as interferons, antiviral proteins induced by interferons, TNF-.alpha., and TNF-.beta.; enzymes such as cathepsin K, cytochrome P-450 and other cytochromes, farnesyl transferase, glutathione-s transferases, heparanase, HMG CoA synthetase, N-acetyltransferase, phenylalanine hydroxylase, phosphodiesterase, ras carboxyl-terminal protease, telomerase and TNF converting enzyme; glycoproteins such as cadherins, e.g., N-cadherin and E-cadherin; cell adhesion molecules; transmembrane glycoproteins such as CD40; heat shock proteins; hormones such as 5-.alpha. reductase, atrial natriuretic factor, calcitonin, corticotrophin releasing factor, diuretic hormones, glucagon, gonadotropin, gonadotropin releasing hormone, growth hormone, growth hormone releasing factor, somatotropin, insulin, leptin, luteinizing hormone, luteinizing hormone releasing hormone, parathyroid hormone, thyroid hormone, and thyroid stimulating hormone; proteins involved in immune responses, including antibodies, CTLA4, hemagglutinin, MHC proteins, VLA-4, and kallikrein-kininogen-kinin system; ligands such as CD4; oncogene products such as sis, hst, protein tyrosine kinase receptors, ras, abl, mos, myc, fos, jun, H-ras, ki-ras, c-fms, bcl-2, L-myc, c-myc, gip, gsp, and HER-2; receptors such as bombesin receptor, estrogen receptor, GABA receptors, growth factor receptors including EGFR, PDGFR, FGFR, and NGFR, GTP-binding regulatory proteins, interleukin receptors, ion channel receptors, leukotriene receptor antagonists, lipoprotein receptors, opioid pain receptors, substance P receptors, retinoic acid and retinoid receptors, steroid receptors, T-cell receptors, thyroid hormone receptors, TNF receptors; tissue plasminogen activator; transmembrane receptors; transmembrane transporting systems, such as calcium pump, proton pump, Na/Ca exchanger, MRP1, MRP2, P170, LRP, and cMOAT; transferrin; and tumor suppressor gene products such as APC, brca1, brca2, DCC, MCC, MTS1, NF1, NF2, nm23, p53 and Rb, or fragments thereof.

Small Molecules

The small molecules identified according to the methods described herein can be obtained from commercial sources or can be synthesized from readily available starting materials using standard synthetic techniques and methodologies known to those of ordinary skill in the art. Synthetic chemistry transformations and protecting group methodologies (protection and deprotection) useful in synthesizing the compounds identified by the methods described herein are known in the art and include, for example, those such as described in R. Larock, Comprehensive Organic Transformations, VCH Publishers (1989); T. W. Greene and P. G. M. Wuts, Protective Groups in Organic Synthesis, 2nd ed., John Wiley and Son's (1991); L. Fieser and M. Fieser, Fieser and Fieser's Reagents for Organic Synthesis, John Wiley and Sons (1994); and L. Paquette, ed., Encyclopedia of Reagents for Organic Synthesis, John Wiley and Sons (1995), and subsequent editions thereof.

In certain embodiments, the small molecules can be peptidic, non-peptidic, or a combination thereof. Small molecules having a non-peptidic component can comprise any structure, and include, without limitation, non-cyclic, heterocyclyl ring groups, or heteroaryl ring groups, which may bear further substituents and can be in their respective pharmaceutically acceptable salt forms. The term “heterocyclyl” refers to a nonaromatic 3-8 membered monocyclic, 8-12 membered bicyclic, or 11-14 membered tricyclic ring system having 1-3 heteroatoms if monocyclic, 1-6 heteroatoms if bicyclic, or 1-9 heteroatoms if tricyclic, said heteroatoms selected from O, N, or S (e.g., carbon atoms and 1-3, 1-6, or 1-9 heteroatoms of N, O, or S if monocyclic, bicyclic, or tricyclic, respectively), wherein 0, 1, 2 or 3 atoms of each ring can be substituted by a substituent. The term “heteroaryl” refers to an aromatic 5-8 membered monocyclic, 8-12 membered bicyclic, or 11-14 membered tricyclic ring system having 1-3 heteroatoms if monocyclic, 1-6 heteroatoms if bicyclic, or 1-9 heteroatoms if tricyclic, said heteroatoms selected from O, N, or S (e.g., carbon atoms and 1-3, 1-6, or 1-9 heteroatoms of N, O, or S if monocyclic, bicyclic, or tricyclic, respectively), wherein 0, 1, 2, 3, or 4 atoms of each ring can be substituted by a substituent. The term “substituents” refers to a group “substituted” on an alkyl, cycloalkyl, aryl, heterocyclyl, or heteroaryl group at any atom of that group. Suitable substituents include, without limitation, alkyl, alkenyl, alkynyl, alkoxy, halo, hydroxy, cyano, nitro, amino, SO.sub.3H, perfluoroalkyl, perfluoroalkoxy, methylenedioxy, ethylenedioxy, carboxyl, oxo, thioxo, imino (alkyl, aryl, aralkyl), S(O)nalkyl (where n is 0-2), S(O).sub.n aryl (where n is 0-2), S(O).sub.n heteroaryl (where n is 0-2), S(O).sub.n heterocyclyl (where n is 0-2), amine (mono-, di-, alkyl, cycloalkyl, aralkyl, heteroaralkyl, and combinations thereof), ester (alkyl, aralkyl, heteroaralkyl), amide (mono-, di-, alkyl, aralkyl, heteroaralkyl, and combinations thereof), sulfonamide (mono-, di-, alkyl, aralkyl, heteroaralkyl, and combinations thereof), unsubstituted aryl, unsubstituted heteroaryl, unsubstituted heterocyclyl, and unsubstituted cycloalkyl. In one aspect, the substituents on a group are independently any one single, or any subset of the aforementioned substituents.

Pharmaceutically acceptable salts of the small molecules described herein include, but are not limited to, those derived from pharmaceutically acceptable inorganic and organic acids and bases. Non limiting examples of suitable acid salts include acetate, adipate, alginate, aspartate, benzoate, benzenesulfonate, bisulfate, butyrate, citrate, digluconate, ethanesulfonate, formate, fumarate, glycolate, hemisulfate, heptanoate, hexanoate, hydrochloride, hydrobromide, hydroiodide, lactate, maleate, malonate, methanesulfonate, 2-naphthalenesulfonate, nicotinate, nitrate, palmoate, pectinate, persulfatephosphate, picrate, pivalate, propionate, salicylate, succinate, sulfate, tartrate, thiocyanate, tosylate, and undecanoate.

The small molecules described herein can contain one or more asymmetric centers and thus occur as racemates and racemic mixtures, single enantiomers, individual diastereomers and diastereomeric mixtures. All such isomeric forms of these compounds are expressly included in the present invention. The compounds described herein can also be represented in multiple tautomeric forms, all of which are included herein. The compounds can also occur in cis- or trans- or E- or Z-double bond isomeric forms. All such isomeric forms of such compounds are expressly included in the present invention.

Computer Systems

The computations described herein, including the molecular dynamics simulations, docking, scoring, modeling or any other computation methods described herein, can be performed using a variety of hardware and/or software based systems. When used in connection with the methods described herein, such hardware and/or software based systems can comprise a simulation engine. In certain embodiments, a simulation engine can be a system that employs parallel computation. Parallel computation can use a variable number of interconnected computation nodes. Parallel computation can also use a general-purpose computer for each node where each node is interconnected using one or more data links or networks.

The methods described herein can be implemented in digital electronic circuitry, or in computer hardware, firmware, software, or in combinations thereof. Computer assistance allows powerful manipulations of chemical structural data and permits automation. Furthermore, computer assistance makes possible the simultaneous comparison and recombination of multiple molecules. In one embodiment, an apparatus (e.g., a computer) can contain computer instructions and systems that effect molecular modeling. The instructions and systems can be implemented in a computer program product tangibly embodied in a machine-readable storage device for execution by a programmable processor; and method actions can be performed by a programmable processor executing the instructions to perform molecular modeling by operating on input data and generating output.

The steps of the modeling methods can include both steps implemented by commercially available software packages, and steps implemented by instructions provided by a scripting language (e.g., Perl, Python), or a compiled language (e.g., C, Fortran). Also, the steps can be integrated using instructions provided with a computer language, such as those mentioned above.

The methods and systems described herein can be implemented advantageously in one or more computer programs that are executable on a programmable system including at least one programmable processor coupled to receive data and instructions from, and to transmit data and instructions to, a data storage system, at least one input device, and at least one output device. Suitable processors include, by way of example, both general and special purpose microprocessors. Generally, a processor will receive instructions and data from a read-only memory and/or a random access memory. Generally, a computer can include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD_ROM disks. Any of the foregoing can be supplemented by, or incorporated in, ASICs (application-specific integrated circuits).

By way of example a computer system suitable for use with the methods described herein can comprise a programmable processing system suitable for implementing or performing the apparatus or methods of the invention. The system can include a processor, a random access memory (RAM), a program memory (for example, a writable read-only memory (ROM) such as a flash ROM), a hard drive controller, and an input/output (I/O) controller coupled by a processor (CPU) bus. The system can be preprogrammed, in ROM, for example, or it can be programmed (and reprogrammed) by loading a program from another source (for example, from a floppy disk, a CD-ROM, or another computer).

The hard drive controller can be coupled to a hard disk suitable for storing executable computer programs, including programs embodying the present invention, and data including storage. The I/O controller can be coupled by means of an I/O bus to an I/O interface, that can include one or more of the following: a monitor, a mouse, a keyboard or other input device. The I/O interface receives and transmits data in analog or digital form over communication links such as a serial link, local area network, wireless link, and parallel link.

The following examples illustrate the present invention, and are set forth to aid in the understanding of the invention. These examples should not be construed to limit in any way the scope of the invention as defined in the claims which follow thereafter.

### EXAMPLES

### Example 1

### In Silico Induction of Potential Drug Binding Sites Using Helices Derived from Protein-Protein Interaction

Alpha-helices are involved at the binding interface in the majority of protein-protein interactions. Starting from a complex structure, a reduced complex of a target protein and a helix of the ligand can be constructed and then simulated. In certain embodiments of the methods described herein the helix is in complex with the target protein and serves as a mimic.

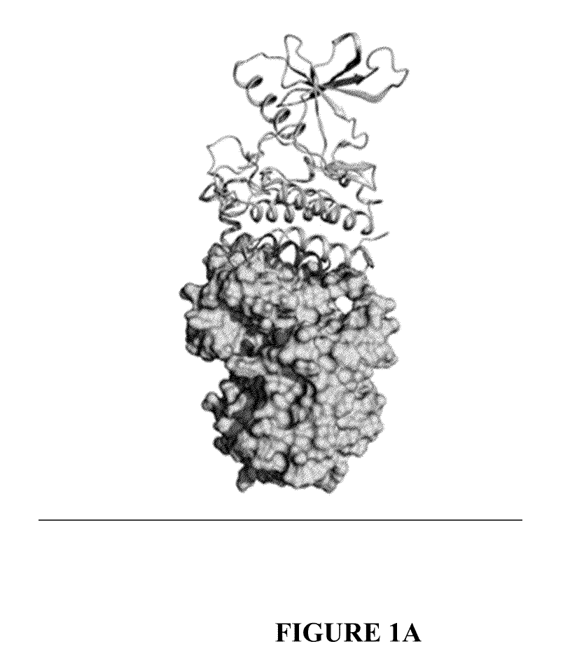

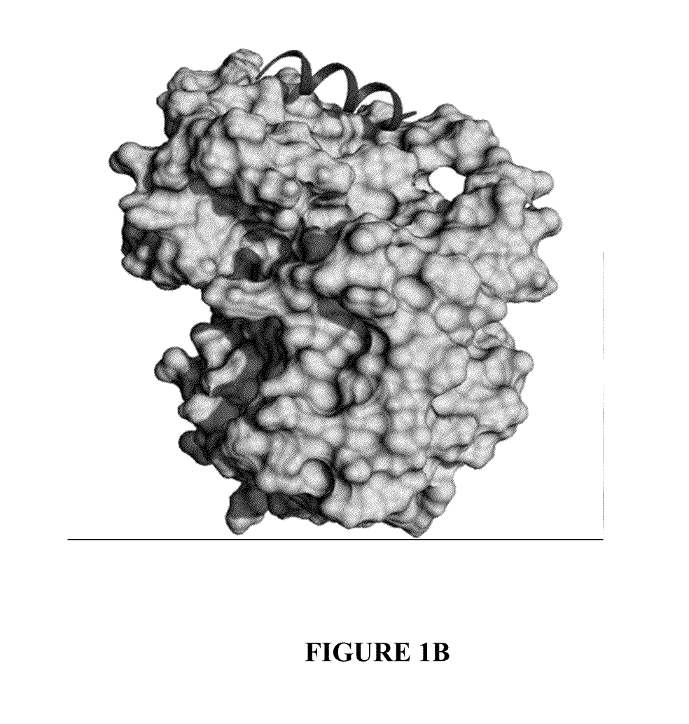

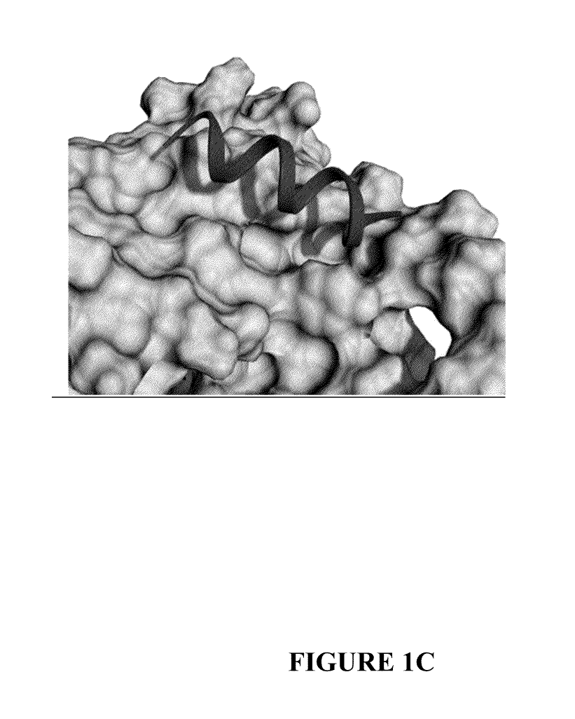

In this example, the EGFR kinase is used as an assay system. An active EGFR kinase forms a dimer (FIG. 1A). The structure is used to construct a reduced complex of an EGFR kinase (target protein) and a helix (ligand) at the dimer interface (FIGS. 1B and 1C).

The simulation system was based on an EGFR kinase homo-dimer structure (pdb: 2gs6) as a template, from which a protein-peptide complex was derived and then simulated. In this complex, the protein with the protein-protein interface adjacent to its amino-terminus remains intact, while the other protein in the dimer structure, where the interface is adjacent to its carboxyl terminus, was removed other than its αH helix (residue 940-952). Then explicit-solvent classic MD simulation was performed using Anton for bus. The conformations generated from the simulation were inspected, and three of them (snapshots at 508 ns, 540 ns, and 1.5 us) were chosen for docking. These three snapshots were chosen because they exhibit a well-developed and relatively deep binding groove adjacent to the remaining alpha helix H. (SiteMap software of Schrodinger Inc and manual visual inspection were used to identify the cleft.) Glide SP 2008 of Schrodinger Inc. was used on the virtual chemical library that represents the ˜236,000 chemical compounds stocked in the Small Molecule Discovery Center of UCSF at year 2010. The chemical libraries were prepared using Ligprep 2008 software of Schrodinger Inc.

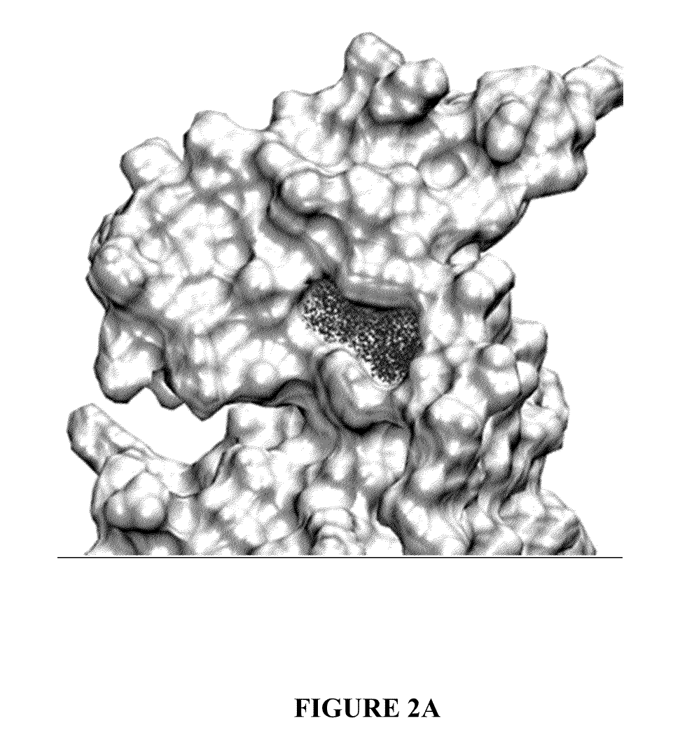

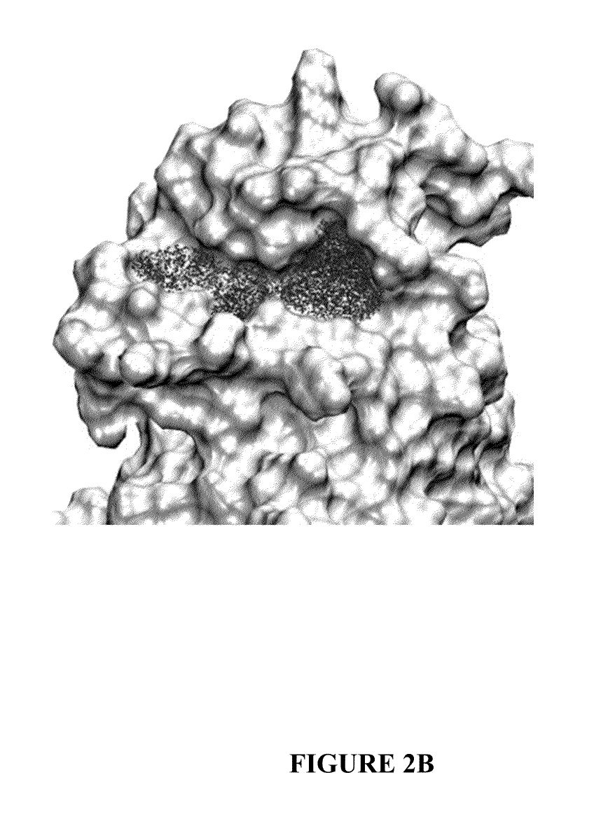

Simulation of the reduced complex has captured a well-formed evolved three dimensional topological feature on the target protein that is not present in the same location in the X-ray structure (FIG. 2A). This three dimensional topological feature is a stable binding site induced by the helix (FIG. 2B).

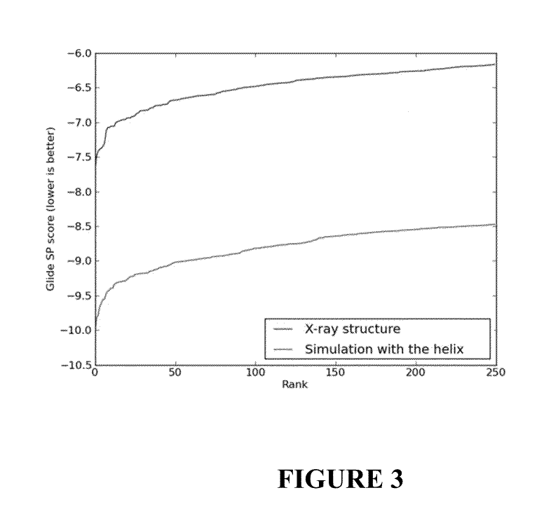

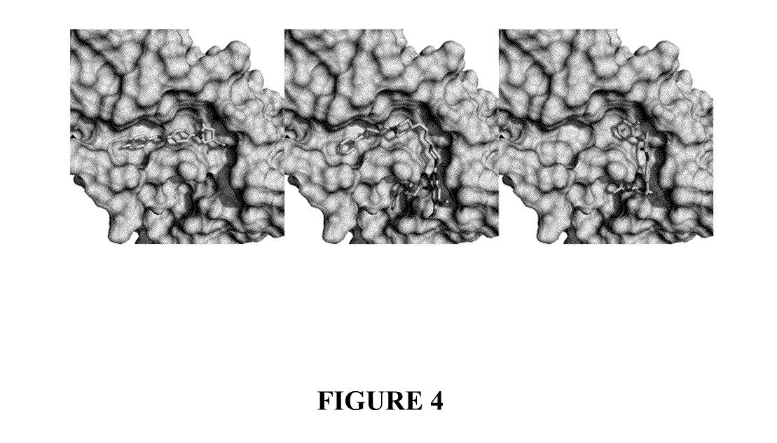

Virtual screening (i.e. docking) applied to this three dimensional topological feature shows that this helix-induced binding site is far more “druggable” than the binding sites in the X-ray structure (FIG. 3). Candidate small-molecule binders are obtained from the virtual screen (FIG. 4).

What is claimed is:

1. A method of computer-assisted identification of a compound that modulates an activity of a target protein, the method comprising:
(a) providing a structure of the target protein in complex with a biomolecule, or a fragment thereof,
(b) performing a long timescale molecular dynamics simulation of the structure,
(c) identifying one or more evolved three dimensional topological features on the target protein of the structure of step (a), and
(d) identifying a compound that binds to at least one of the one or more evolved three dimensional topological features identified in step (c), wherein binding of the compound to the one or more evolved three dimensional topological features modulates an activity of the target protein.

2. A method of computer-assisted identification of a compound that modulates an interaction between a target protein and a biomolecule, wherein the biomolecule is a binding partner of the target protein, the method comprising:
(a) providing a structure of the target protein in complex with a biomolecule, or a fragment thereof,
(b) performing a long timescale molecular dynamics simulation of the structure,
(c) identifying one or more evolved three dimensional topological features on the target protein of the structure of step (a), and
(d) identifying a compound that binds to at least one of the one or more evolved three dimensional topological features identified in step (c) wherein binding of the compound to the one or more evolved three dimensional topological features modulates an interaction between the target protein and the biomolecule or fragment thereof.

3. A method of computer-assisted identification of one or more evolved three dimensional topological features on a target protein, the method comprising:
(a) providing a structure of the target protein in complex with a biomolecule, or a fragment thereof,
(b) performing a long timescale molecular dynamics simulation of the structure,
(c) identifying one or more evolved three dimensional topological features on the target protein of the structure of step (a).

4. The method of any of claims 1-3, wherein the structure of step (a) is determined by NMR, X-ray crystallography, electron microscopy, in-silico modeling, or any combination thereof.

5. The method of any of claims 1-3, wherein the structure of step (a) is a predicted structure.

6. The method of any of claims 1-3, wherein the complex of step (a) comprises one or more covalent bonds.

7. The method of any of claims 1-3, wherein the complex of step (a) comprises one or more non-covalent interactions.

8. The method of any of claims 1-3, wherein the biomolecule, or a fragment thereof, is a known binding partner of the target protein.

9. The method of any of claims 1-3, wherein the biomolecule, or a fragment thereof, is a polypeptide, or a nucleic acid.

10. The method of any of claims 1-3, wherein the biomolecule, or a fragment thereof, comprises at least one of an alpha helix, a beta strand, a beta sheet, a beta hairpin, a greek key, an omega loop, a Helix-loop-helix, a helix-turn-helix, or a zinc finger motif.

11. The method of any of claims 1-3, wherein the long timescale molecular dynamics simulation of step (b) is performed by a computer program using a physics method, an energy based method, a neutral territory method, an Ewald summation method for molecular simulation, a spatial decomposition method, a force decomposition method, or any combination thereof.

12. The method of any of claims 1-3, wherein the long timescale molecular dynamics simulation is at least 100 nanoseconds.

13. The method of any of claims 1-3, wherein the long timescale molecular dynamics simulation is at least 1000 nanoseconds.

14. The method of any of claims 1-3, wherein the identification of the one or more evolved three dimensional topological features of step (c) is performed by a geometric algorithm, an energy based algorithm, a precedence based algorithm, or any combination thereof.

15. The method of any of claims 1-3, wherein the evolved three dimensional topological feature is selected from the group comprising a groove, a hydrophobic pocket, a cavity or a cleft.

16. The method of any of claims 1-3, wherein the evolved three dimensional topological feature exists transiently during the molecular dynamics simulation, exists at the termination of the molecular dynamics simulation, or a combination thereof.

17. The method of any of claims 1-3, wherein the evolved three dimensional topological feature has a volume between about 50 A°³ to about 3000 A°³ as determined with Surface Cavity REcognition and EvaluatioN.

18. The method of any of claims 1-3, wherein the evolved three dimensional topological feature has a volume of about 50 A°³ to about 2000 A°³ as determined with PocketFinder.

19. The method of claim 1 or claim 2, wherein the identifying of step (d) is performed by a computer program by docking, shape-based matching, free energy analysis, three-dimensional pharmacophore analysis, de novo drug design, fragment-based drug design, or any combination thereof.

20. The method of any of claims 1-3, wherein at least one of the one or more evolved three dimensional topological features comprises an amino acid residue that forms a non-covalent interaction with an amino acid residue of the biomolecule, or a fragment thereof.

21. The method of claim 1 or claim 2, wherein at least one of the one or more evolved three dimensional topological features comprises an amino acid residue that forms a non-covalent interaction with the compound of step (d).

22. The method of claim 20, wherein the non-covalent interaction is selected from the group comprising an ionic interaction, an electrostatic interaction, a hydrogen bond, a van der Walls interaction or a hydrophobic interaction.

23. The method of claim 21, wherein the non-covalent interaction is selected from the group comprising an ionic interaction, an electrostatic interaction, a hydrogen bond, a van der Walls interaction or a hydrophobic interaction.

24. The method of claim 1 or claim 2, wherein the compound has a molecular weight from about 100 daltons to about 1000 daltons.

25. The method of claim 1 or claim 2, wherein the compound comprises a chemical group selected from the group consisting of hydrogen, alkyl, alkoxy, phenoxy, alkenyl, alkynyl, phenylalkyl, hydroxyalkyl, haloalkyl, aryl, arylalkyl, alkyloxy, alkylthio, alkenylthio, phenyl, phenylalkyl, phenylalkylthio, hydroxyalkyl-thio, alkylthiocarbbamylthio, cyclohexyl, pyridyl, piperidinyl, alkylamino, amino, nitro, mercapto, cyano, hydroxyl, a halogen atom, halomethyl, an oxygen atom (forming a ketone or N-oxide) and a sulphur atom (forming a thione).

26. The method of claim 1 or claim 2, wherein the compound is a polypeptide comprising at least a sequence of at least 4 amino acids.

27. The method of claim 1, wherein the modulation is a decrease of an activity of the target protein.

28. The method of claim 1, wherein the modulation is an increase of an activity of the target protein.

29. The method of claim 2, wherein the modulation is a decrease of the interaction between the target protein and the biomolecule, or a fragment thereof.

30. The method of claim 2, wherein the modulation is an increase in the interaction between the target protein and the biomolecule, or a fragment thereof.

31. A method of computer-assisted identification of a compound that modulates an interaction between a target protein and an alpha helix biomolecule, wherein the alpha helix biomolecule is a binding partner of the target protein, the method comprising:
(a) providing an X-ray structure of the target protein in complex with an alpha helix biomolecule, wherein the complex between the target protein and the alpha helix biomolecule comprises one or more non-covalent interactions,
(b) performing a long timescale molecular dynamics of the structure using an explicit-solvent classic simulation
(c) identifying at least one cleft formed on the target protein of step (a) using SiteMap or manual visual inspection, and
(d) performing virtual screening to identify at least one compound that binds to at least one of the clefts of step (c) using the Glide SP 2008 docking algorithm.
